(19) United States
(12) Patent Application Publication
(10) Pub. No.: US 2011/0093943 A1
(43) Pub. Date: Apr. 21, 2011

(54) AUTOMATIC ACCESS SYSTEM, HOST COMPUTER, DEVICE, RESPONSE DEVICE, REMOTE CODE READER SYSTEM, BARCODE READER, AUTOMATIC ACCESS METHOD, AUTHENTICATION METHOD, COMPUTER PROGRAM, AND RECORDING MEDIUM

(76) Inventors: Katsuya Nakagawa, Shiga (JP); Shuhei Kato, Shiga (JP)

(21) Appl. No.: 12/743,540

(22) PCT Filed: Nov. 14, 2008
(86) PCT No.: PCT/JP2008/003331

§ 371 Date: Nov. 18, 2010

(30) Foreign Application Priority Data
Nov. 19, 2007 (JP) 2007-299477
Nov. 22, 2007 (JP) 2007-303783
Dec. 21, 2007 (JP) 2007-330916

(51) Int. Cl. H04L 9/32; G06F 21/00

(52) U.S. Cl. 726/9

(57) ABSTRACT

A terminal 5 to which a USB device 7 is connected accesses a host computer 1 firstly to transmit a serial number of the USB device 7. The host computer 1 accesses a database 11 with the serial number as an index to retrieve a URL related to the serial number, and instructs the terminal to access the URL. Hence, a WEB page is sent from a WEB server W-2 addressed by the URL to the terminal 5, and is displayed on the terminal 5. In this way, the host computer 1 can subsequently determine the WEB server to be accessed in accordance with the serial number because of the fact of absolutely passing through the host computer 1.

### TECHNICAL FIELD

The present invention relates to an automatic access system and the related arts for responding to connection of a device or scanning of a code, and leading a terminal to a specified resource on a network.

Also, the present invention relates to a remote code reader system and the related arts for collecting and processing codes (for example, barcodes) which are transmitted from local code readers.

Further, the present invention relates to a barcode reader with a mouse function and the related arts.

### BACKGROUND ART

Patent Document 1 (Japanese Unexamined Patent Application Publication 2003-216586) discloses a USB access key. By just inserting the USB access key into a terminal, the terminal automatically accesses a specified WEB server addressed by a URL which is stored in the USB access key, and displays an WEB page.

### DISCLOSURE OF THE INVENTION

### Problem to be Solved by the Invention

However, in Patent Document 1, the terminal performs the automatic access by the URL which is stored in the USB access key at the time of production. That is, a destination of the automatic access is preliminarily determined. If it is possible to set the destination of the automatic access after the production, i.e., if it is possible to subsequently set the destination of the automatic access, it is convenient.

It is therefore an object of the present invention to provide an automatic access system and the related arts capable of setting a destination of automatic access subsequently.

By the way, Patent Document 2 (International publication WO/2007/77976) discloses a remote code reader system of the present applicant. This system is, for example, applied to an online game which uses a barcode.

However, since the barcode can be copied, unauthorized copies are distributed, and thereby business is disturbed.

It is therefore another object of the present invention to provide a remote code reader system and the related arts capable of weeding out use of an unauthorized copy of a code as much as possible.

By the way, in a section of prior art in Patent Document 3 (Japanese Unexamined Patent Application Publication 7-216586), a pen type barcode reader is disclosed.

However, as far as the present applicant and the present inventor know, a pen type barcode reader with a mouse function does not exist.

It is, therefore, further another object of the present invention to provide a pen type barcode reader with a mouse function and the related arts.

### Solution of the Problem

In accordance with a first aspect of the present invention, an automatic access system comprising: a device configured to be freely removably connected to a terminal connected to a network; and a host computer configured to be connected to the network, wherein said device including: a storing unit configured to store identification information assigned to said device and address information of said host computer (hereinafter referred to as “host address information”); and an information processing unit configured to transmit the identification information and the host address information to the terminal in response to that said device is connected to the terminal, wherein said host computer receives the identification information which the terminal transmits on the basis of the host address information in response to the connection of said device, retrieves address information item related to the received identification information from address information items of a plurality of resources on the network, and transmits the retrieved address information item to the terminal.

In accordance with this configuration, the terminal to which the device is connected accesses the host computer firstly to transmit the identification information of the device. That is, the terminal passes through the host computer absolutely instead of accessing the resource directly. Accordingly, the host computer can determine the resource to be accessed by the terminal from among the plurality of the resources in accordance with the identification information. That is, even after the delivery of the device (including a period after the device is distributed to an end-user), the host computer can determine, only by changing the address (of the resource) to which the identification information of the device is related, the destination of the automatic access of the terminal to which the device is connected. In this way, it is possible to subsequently determine the destination of the automatic access of the terminal to which the device is connected, and therefore it is convenient.

In the case where it is possible to subsequently determine the destination of the automatic access of the terminal to which the device is connected, examples of the advantage thereof will be described.

Since the address information which is preliminarily stored in the device is not the address information of the resource but the address information of the host computer (the host address information), the address information is not given by an orderer of the device, and the destination of the automatic access can be subsequently determined. Accordingly, it is possible to preliminarily mass-produce the devices in advance of order entry. As the result, a large number of order receivers can benefit from the cost reduction from the beginning. In passing, in the case where the devices store the address information of the resource, since the devices are dedicated devices for the orderer, only the orderer can sell the devices.

Besides, even after the device is distributed to the end-user, the host computer can dynamically change, only by changing the address information (of the resource) to which the identification information of the device is related, the destination of the automatic access without accessing the terminal and the device of the end-user. For example, it is assumed that a rewritable memory such as an EEPROM is incorporated in a device, address information (of the resource) is written in the memory, and then the address information is rewritten. However, in this case, since a host computer needs to access a terminal and the device of an end-user, the user may be anxious about security and therefore refuse the rewriting, and the large labor hour is imposed on the user and the host computer. Also, for example, it is assumed that address information of a resource (referred to as an “initial resource”) is stored in a device. In this case, in the case where leading to a resource (referred to as a “new resource”) other than the initial resource is desired, it is required to assign the address information stored in the device to the new resource, and change or close the address information of the initial resource, and therefore it is not convenient.

Further, since the address information of the resource and the identification information, i.e., the resource and the device are one-on-one related to each other, it is possible to distribute the devices as dedicated devices for an operating entity running the resource. In addition, in the case where the operating entity desires to lead to another resource, it is possible to lead to the another resource only by relating the identification information of the devices distributed as the dedicated devices for the operating entity to the address information of the another resource.

Incidentally, meaning of the term “resource” includes a computer on a network such as a server, and a directory, a file, an image, a sound, a document, and so on in the computer.

In this automatic access system, wherein said storing unit of said device stores a command to an operating system of the terminal, wherein said information processing unit transmits the command to the terminal together with the identification information and the host address information in response to that the device is connected to the terminal, and wherein said host computer receives the identification information which the terminal transmits on the basis of the host address information in response to the command.

In accordance with this configuration, since the command which the device sends to the terminal is a command for instructing the operating system, the end-user is not required to newly install software in the terminal for transmitting the identification information to the host computer by the terminal, and thereby it is possible to improve the convenience of the user.

In accordance with a second aspect of the present invention, an automatic access system comprising: a plurality of devices each of which is connected to a corresponding terminal connected to a network, and reads a code; and a host computer configured to receive a plurality of the codes sent by the plurality of said devices, wherein each of said devices including: a storing unit configured to store identification information as assigned and address information of said host computer (hereinafter referred to as “host address information”); and an information processing unit configured to transmit the code, the identification information, and the host address information to the corresponding terminal in response to the read of the code, wherein said host computer receives the code and the identification information which the terminal transmits on the basis of the host address information, retrieves address information item related to the received identification information from address information items of a plurality of resources on the network, and transmits the retrieved address information item to the terminal, and indirectly or directly transmits the received code to the resource indicated by the retrieved address information item.

In accordance with this configuration, the terminal, to which the code, the identification information, and the host address information are sent by the device for reading the code, firstly accesses the host computer with reference to the host address information, and transmits the identification information and the code. That is, the terminal passes through the host computer absolutely instead of accessing the resource directly. Accordingly, the host computer can determine the resource to be accessed by the terminal from among the plurality of the resources in accordance with the identification information. In this way, it is possible to subsequently determine the destination of the automatic access of the terminal to which the device for reading the code is connected, and therefore it is convenient.

In the case where it is possible to subsequently determine the destination of the automatic access of the terminal to which the device for reading the code is connected, the advantage thereof is similar to the above automatic access system according to the first aspect.

Also, the terminal, i.e., the user can receive the content provided corresponding to the code read by the device from the resource addressed by the address information sent from the host computer.

In addition, the invention has advantage similar to the above automatic access system according to the first aspect.

Incidentally, meaning of the term “resource” includes a computer on a network such as a server, and a directory, a file, an image, a sound, a document, and so on in the computer.

In this automatic access system, wherein said storing unit of said device stores a command to an operating system of the terminal, wherein said information processing unit transmits the command to the terminal together with the code, the identification information, and the host address information in response to the read of the code, and wherein said host computer receives the identification information and the code which the terminal transmits on the basis of the host address information in response to the command.

In accordance with this configuration, since the command which the device for reading the code sends to the terminal is a command for instructing the operating system, the end-user is not required to newly install software in the terminal for transmitting the identification information to the host computer by the terminal, and thereby it is possible to improve the convenience of the user.

In accordance with a third aspect of the present invention, an automatic access system comprising: a responding unit configured to be installed on a terminal connected to a network, and perform processing in response to that a device is connected to the terminal; and a host computer configured to be connected to the network, wherein said responding unit transmits identification information on a side of the device to the host computer on the basis of address information of said host computer (hereinafter referred to as “host address information”) in response to that the device is connected to the terminal, and wherein said host computer receives the identification information, retrieves address information item related to the received identification information from address information items of a plurality of resources on the network, and transmits the retrieved address information item to the terminal.

In accordance with this configuration, the invention has advantage similar to the above automatic access system according to the first aspect.

Although the above automatic access system according to the first aspect can realize the automatic access to the host computer even when the dedicated software is not installed in the terminal (needless to say, it may be installed), the present invention realizes the automatic access by installing the responding unit in the terminal.

Also, for example, the identification information on the side of the device includes at least one of identification information of the device, identification information of the terminal, and identification information of a user.

In accordance with a fourth aspect of the present invention, an automatic access system comprising: a device configured to be connected to a terminal connected to a network, and read a code; a responding unit configured to be installed on the terminal, and perform processing in response to that said device is connected to the terminal; and a host computer configured to be connected to the network, wherein said responding unit transmits the code sent by said device and identification information on a side of said device to said host computer on the basis of address information of said host computer (hereinafter referred to as “host address information”), and wherein said host computer receives the code and the identification information, retrieves address information item related to the received identification information from address information items of a plurality of resources on the network, and transmits the retrieved address information item to the terminal, and indirectly or directly transmits the received code to the resource indicated by the retrieved address information item.

In accordance with this configuration, the invention has advantage similar to the above automatic access system according to the second aspect.

Although the above automatic access system according to the second aspect can realize the automatic access to the host computer even when the dedicated software is not installed in the terminal (needless to say, it may be installed), the present invention realizes the automatic access by installing the responding unit in the terminal.

Also, for example, the identification information on the side of the device for reading the code includes at least one of identification information of the device, identification information of the terminal, and identification information of a user.

In the above automatic access systems according to the third and fourth aspects, wherein the identification information and/or the host address information are/is sent to said responding unit by said device.

In the above automatic access systems according to the first to fourth aspects, wherein said device is a USB (Universal Serial Bus) device.

In accordance with this configuration, since the USB of a widely diffused interface standard is employed, more end-users can easily use the present system.

In the above automatic access systems according to the first to third aspects, wherein said device is a code reader which reads and decodes a code.

In accordance with this configuration, the terminal to which the code reader is connected accesses the host computer firstly to transmit the identification information of the code reader. Accordingly, the host computer can determine the resource to be accessed by the terminal from among the plurality of the resources in accordance with the identification information. In this way, it is possible to subsequently determine the destination of the automatic access of the terminal to which the code reader is connected, and therefore it is convenient.

In this automatic access system and the above automatic access systems according to the second and fourth aspects, wherein said host computer receives the code decoded by said device from the terminal, and indirectly or directly transmits the code to the resource indicated by the address information item related to the identification information of said device.

In accordance with this configuration, since the code is transmitted to the resource corresponding to the identification information, it is possible to provide the content corresponding to the code from the resource to the terminal.

In the above automatic access systems according to the first to fourth aspects, wherein said device is set so as to be recognized as a keyboard by the terminal.

In accordance with this configuration, since it is possible to send the data (e.g., the identification information, the host address information, the command, and the code information) in the form of the keyboard data to the terminal, it is possible to use the function of the operating system of the terminal as it is. As the result, it is not required for the terminal to install dedicated software by realizing the automatic access to the host computer using the function of the operating system of the terminal, and therefore it is possible to improve the convenience of the user. Incidentally, although the automatic access systems according to the third and fourth aspects require to install the responding unit, it is easily possible to realize the automatic access system even before installing.

In the above automatic access systems according to the first to fourth aspects, wherein said device is connected to the terminal in a wired manner or wireless manner.

In the above automatic access system, wherein the code includes a one-dimensional code, a two-dimensional code, and/or a code which is stored in an IC tag. For example, the one-dimensional code is a one-dimensional barcode, the two-dimensional code is a QR code, and the IC tag is an RFID tag.

In accordance with a fifth aspect of the present invention, a host computer is the host computer of the automatic access system according to any one of the first to fourth aspects.

In accordance with a sixth aspect of the present invention, a device is the device of the automatic access system according to any one of the first to fourth aspects.

In accordance with a seventh aspect of the present invention, a responding device includes the responding unit according to the third aspect or the fourth aspect.

In accordance with a eighth aspect of the present invention, an automatic access method utilizing a device configured to be freely removably connected to a terminal connected to a network, and a host computer configured to be connected to the network, comprising the steps of: by the host computer, receiving identification information on a side of the device which the terminal transmits on the basis of address information of the host computer (hereinafter referred to as “host address information”) in response to the connection of the device; by the host computer, retrieving address information item related to the received identification information from address information items of a plurality of resources on the network; and by the host computer, transmitting the retrieved address information item to the terminal. In accordance with this configuration, the invention has advantage similar to the above automatic access system according to the first aspect.

Also, for example, the identification information on the side of the device includes at least one of identification information of the device, identification information of the terminal, and identification information of a user.

In accordance with a ninth aspect of the present invention, an automatic access method utilizing a plurality of devices each of which is connected to a corresponding terminal connected to a network, and reads a code, and a host computer configured to receive a plurality of the codes sent by the plurality of said devices, comprising the steps of: by the host computer, receiving the code and identification information on a side of the device which the terminal transmits on the basis of address information of the host computer (hereinafter referred to as “host address information”) in response to the read of the code by the device; by the host computer, retrieving address information item related to the received identification information from address information items of a plurality of resources on the network; by the host computer, transmitting the retrieved address information item to the terminal; and by the host computer, transmitting the received code indirectly or directly to the resource indicated by the retrieved address information item. In accordance with this configuration, the invention has advantage similar to the above automatic access system according to the second aspect.

Also, for example, the identification information on the side of the device for reading the code includes at least one of identification information of the device, identification information of the terminal, and identification information of a user.

In accordance with a tenth aspect of the present invention, an automatic access method utilizing a device configured to be freely removably connected to a terminal connected to a network, and a host computer configured to be connected to the network, comprising the steps of: transmitting identification information on a side of the device to the host computer on the basis of address information of said host computer (hereinafter referred to as “host address information”) in response to that the device is connected to the terminal; and receiving address information item related to the identification information received by the host computer, of address information items of a plurality of resources on the network, from the host computer. In accordance with this configuration, the invention has advantage similar to the above automatic access system according to the third aspect.

In accordance with a eleventh aspect of the present invention, an automatic access method utilizing a plurality of devices each of which is connected to a corresponding terminal connected to a network, and reads a code, and a host computer configured to receive a plurality of the codes sent by the plurality of said devices, comprising the steps of: transmitting the code sent by the device and identification information on a side of the device to the host computer on the basis of address information of the host computer (hereinafter referred to as “host address information”); and receiving address information item related to the identification information received by the host computer, of address information items of a plurality of resources on the network, from the host computer. In accordance with this configuration, the invention has advantage similar to the above automatic access system according to the fourth aspect.

In accordance with a twelfth aspect of the present invention, a computer program enables a computer to perform the automatic access method according to any one of the eighth to eleventh aspects.

In accordance with a thirteenth aspect of the present invention, a computer readable medium embodies the computer program according to the twelfth aspect.

In accordance with a fourteenth aspect of the present invention, a remote code leader system comprising: a plurality of local code leaders each of which is connected to a corresponding communication terminal connected to a network, and reads a code; and a host computer operable to receive a plurality of the codes sent from the plurality of said local code leaders, wherein each of said local code leaders includes a sending unit which sends the code as read to said host computer through the network and the corresponding communication terminal, and wherein said host computer including: a database operable to relate identification information on a side of said local code reader to the code; a receiving unit operable to receive the code and identification information on the side of said local code reader from said communication terminal; a checking unit operable to access said database, and check whether or not the identification information is registered relating to the received code; a registering unit operable to register relating the received identification information to the received code in the database if the registration is absent as the result of the check by the checking unit; a comparing unit operable to compare the identification information registered relating to the received code with the received identification information if the registration is present as the result of the check by the checking unit; a processing unit operable to perform processing depending on the received code if the identification information is not registered relating to the received code as the result of the check by the checking unit, or if the registered identification information is consistent with the received identification information as the result of the comparison by the comparing unit; and a refusing unit operable to perform a first predetermined process irrespective of the received code if the registered identification information is inconsistent with the received identification information as the result of the comparison by the comparing unit.

In accordance with this configuration, the database relates the code to the identification information on the side of the local code reader. If the identification information is not registered relating to the received code, it is believed that the code is sent from the initial purchase user, because of this, it is regarded that the code is original. As the result, the received identification information is registered relating to the code, and the service (the process in accordance with the code) by the present system is provided. On the other hand, if the identification information is registered relating to the received code, the registered identification information is compared with the received identification information. When both are consistent, the code is regarded as the original one, and the service (the process in accordance with the code) by the present system is provided. Conversely, both are inconsistent, it is regarded that the code is copied one transmitted from a person other than an initial purchase user, and therefore the first predetermined process is performed irrespective of the code. The first predetermined process is a process for refusing the service by the present system (the process in accordance with the code) such as a return of an error message and a return of a URL of a well-known portal site. Accordingly, it is possible to weed out use of an unauthorized copy of an original code as much as possible.

In this remote code reader system, wherein the identification information on the side of said local code reader is identification information of said local code reader, said sending unit sends the identification information to said host computer through the network and the corresponding communication terminal.

In this remote code reader system, wherein said sending unit outputs the code, the identification information, address information of said host computer, and a command for instructing said communication terminal to transmit the code and the identification information to said host computer.

In accordance with this configuration, since the terminal transmits the identification information of the local code reader, which is required to perform the authentication (of the code), to the host computer in response to the command, it is possible to weed out use of an unauthorized copy of an original code as much as possible without installing the dedicated software on the terminal. Also, it is possible to transmit the code without installing the dedicated software on the terminal.

In the above remote code reader system, wherein the identification information which said receiving unit receives is included in cookie information.

In accordance with this configuration, by using the widely diffused existing cookie for the authentication (of the code), it is possible to weed out use of an unauthorized copy of an original code as much as possible without installing the dedicated software on the terminal.

In the above remote code reader system, wherein in a case where the identification information is not registered relating to the received code as the result of the check by the checking unit, if the identification information is not included in information as received from said communication terminal, said registering unit generates identification information on the side of said local code reader and registers relating the generated identification information to the received code, wherein said host computer further including: a transmitter operable to transmit the identification information generated by said registering unit to said communication terminal so as to make said communication terminal transmit the identification information in subsequent accesses.

In accordance with this configuration, in the case where the identification information is not registered relating to the received code, if the received information does not include the identification information, it is believed that the new user uses the local code reader for the first time and sends the new code for the first time, because of this, it is regarded that the code is original, and therefore the service (the process in accordance with the code) by the present system is provided.

In this remote code reader system, wherein said transmitter transmits cookie information including the identification information to said communication terminal.

In accordance with this configuration, by using the widely diffused existing cookie, it is possible to weed out use of an unauthorized copy of an original code as much as possible without installing the dedicated software on the terminal.

In the above remote code reader system, wherein in a case where the identification information is registered relating to the received code as the result of the check by the checking unit, if the identification information is not included in information as received from said communication terminal, said refusing unit performs a second predetermined process irrespective of the received code.

In accordance with this configuration, in the case where the identification information is registered relating to the received code, if the received information does not include the identification information, it is regarded that the new user other than the user of the original code uses the new local code reader for the first time and the copy of the original code is sent, and therefore the second predetermined process is performed. The second predetermined process is a process for refusing the service by the present system (the process in accordance with the code) such as a return of an error message and a return of a URL of a well-known portal site. Accordingly, it is possible to weed out use of an unauthorized copy of an original code as much as possible.

In the above remote code reader system, wherein the identification information on the side of said local code reader includes at least one of identification information of said local code reader, identification information of said communication terminal, and identification information of a user.

Incidentally, the identification information on the side of the local code reader may be one stored in the local code reader, one stored in the communication terminal, one input by the user through the communication terminal, or one generated by the host computer.

In the above remote code reader system, wherein said sending unit outputs the code, address information of said host computer, and a command for instructing said communication terminal to transmit the code to said host computer.

In accordance with this configuration, since the terminal transmits the code to the host computer in response to the command, it is possible to transmit the code without installing the dedicated software on the terminal.

In the above remote code reader system, wherein the code includes a one-dimensional code, a two-dimensional code, and/or a code which is stored in an IC tag. For example, the one-dimensional code is a one-dimensional barcode, the two-dimensional code is a QR code, and the IC tag is an RFID tag.

In accordance with a fifteenth aspect of the present invention, a host computer is the host computer of the remote code reader system according to the fourteenth aspect.

In accordance with a sixteenth aspect of the present invention, an authentication method capable of being performed by a host computer connectable with a plurality of local code leaders each of which is capable of reading a code and is connected with a corresponding communication terminal connectable with a network, the host computer being connectable with each of the local code leaders through the network and the corresponding communication terminal, comprising the steps of: receiving the code from the communication terminal; receiving identification information on a side of said local code reader from the communication terminal; accessing a database where identification information on the side of the local code reader and the code are registered relating to each other to check whether or not the identification information is registered relating to the received code; registering relating the received identification information to the received code in the database if the registration is absent as the result of the check; comparing the identification information registered relating to the received code with the received identification information if the registration is present as the result of the check; performing processing depending on the received code if the identification information is not registered relating to the received code as the result of the check; performing processing depending on the received code if the registered identification information is consistent with the received identification information as the result of the comparison; and performing a first predetermined process irrespective of the received code if the registered identification information is inconsistent with the received identification information as the result of the comparison.

In accordance with this configuration, the invention has advantage similar to the above remote code reader system according to the fourteenth aspect.

This authentication method further comprising: in a case where the identification information is not registered relating to the received code as the result of the check, if the identification information is not included in information as received from said communication terminal, generating identification information on the side of said local code reader; and transmitting the identification information as generated to the communication terminal so as to make the communication terminal transmit the identification information in subsequent accesses, wherein said step of registering registers relating the generated identification information to the received code.

In accordance with this configuration, in the case where the identification information is not registered relating to the received code, if the received information does not include the identification information, it is believed that the new user uses the local code reader for the first time and sends the new code for the first time, because of this, it is regarded that the code is original, and therefore the service (the process in accordance with the code) by the present system is provided.

The above authentication method further comprising: in a case where the identification information is registered relating to the received code as the result of the check, if the identification information is not included in information as received from the communication terminal, performing a second predetermined process irrespective of the received code.

In accordance with this configuration, in the case where the identification information is registered relating to the received code, if the received information does not include the identification information, it is regarded that the new user other than the user of the original code uses the new local code reader for the first time and the copy of the original code is sent, and therefore the second predetermined process is performed. The second predetermined process is a process for refusing the service by the present system (the process in accordance with the code) such as a return of an error message and a return of a URL of a well-known portal site. Accordingly, it is possible to weed out use of an unauthorized copy of an original code as much as possible.

In the above authentication method, wherein the identification information on the side of the local code reader includes at least one of identification information of said local code reader, identification information of said communication terminal, and identification information of a user.

Incidentally, the identification information on the side of the local code reader may be one stored in the local code reader, one stored in the communication terminal, one input by the user through the communication terminal, or one generated by the host computer.

In accordance with a seventeenth aspect of the present invention, a computer program enables a computer to perform the authentication method according to the sixteenth aspect.

In accordance with a eighteenth aspect of the present invention, a computer readable medium embodies the computer program according to the seventeenth aspect.

In accordance with a nineteenth aspect of the present invention, a barcode reader with a mouse function, comprising: a light emitting element; an imaging element; a mouse function unit operable to obtain a moving direction and a moving amount of said barcode reader with the mouse function on the basis of a photographed image from said imaging element; and a barcode decoder operable to decode a barcode on the basis of the photographed image, wherein said light emitting element, said imaging element, said mouse function unit, and said barcode decoder are housed in a tubular housing. In this way, the each element (the light emitting element, the imaging element, the mouse function unit, and the barcode decoder) is housed in the tubular housing, and thereby it is possible to provide the so-called pen type barcode reader with the mouse function.

In this case, a cross-section surface of the tubular housing is not limited to a circular shape, and may have any cross-sectional shape such as an ellipsoidal shape, a polygonal shape, any curve profile, any linear shape, and a combination thereof.

In this barcode reader with the mouse function, wherein said imaging element is arranged to overlap with said light emitting element in a longitudinal direction of said barcode reader and on a side, to which said light emitting element emits light.

In accordance with this configuration, since the imaging element is arranged to overlap with the light emitting element in a longitudinal direction of the barcode reader, it is possible to house the light emitting element, the imaging element, the mouse function unit, and the barcode decoder in the tubular housing which is relatively long and thin, and thereby it is possible to provide the so-called pen type barcode reader with the mouse function.

In this barcode reader with the mouse function, wherein said imaging element and said light emitting element are arranged in a linear fashion along the longitudinal direction of said barcode reader. In this case, said imaging element and said light emitting element may be substantially arranged on the same axis.

In the above barcode reader with the mouse function, wherein said barcode decoder converts a result of decoding of the barcode into keyboard data, and outputs the result of the decoding as the keyboard data and a predetermined command as keyboard data for making a predetermined computer perform a predetermined process using the result of the decoding.

In accordance with this configuration, the computer to which the command is input performs the predetermined process in response to the command. Accordingly, there is no need to install dedicated software for making the computer perform the predetermined process using the result of the decode of the barcode, and thereby it is possible to improve the convenience of the user.

In this barcode reader with the mouse function, wherein said barcode decoder outputs address information of a predetermined server as keyboard data to the predetermined computer, and wherein the predetermined command is a command for making the predetermined computer transmit the result of the decoding of the barcode to the predetermined server indicated by the address information.

In accordance with this configuration, the user can transmit the barcode to the predetermined server only by performing the process of reading the barcode, and therefore easily receive the predetermined service from the server.

In the above barcode reader with the mouse function, wherein said barcode decoder decodes the barcode on the basis of pixel data at a predetermined location in the each photographed image, which is acquired by successive photographing of said imaging element during said imaging element moves relative to the barcode printed on a surface to be photographed.

In accordance with this configuration, the barcode is decoded on the basis of the temporally-continued pixel data items at the predetermined location without depending on image analysis for decoding the barcode on the basis of the image of the barcode on the image as obtained by photographing.

The above barcode reader with the mouse function is a pen type barcode reader.

Incidentally, in the present specification and claims, the recording mediums include, for example, a flexible disk, a hard disk, a magnetic tape, a magneto-optical disk, a CD (including CD-ROM, Video-CD), a DVD (including DVD-Video, DVD-ROM, DVD-RAM), a ROM cartridge, a RAM memory cartridge with a battery backup unit, a flash memory cartridge, a nonvolatile RAM cartridge, and so on.

Also, in the present specification and claims, the term “means (unit)” as used herein does not always refer to a physical device but can also refer to software for implementing the functions of this means. Furthermore, the functions of one unit may be implemented by two or more physical devices. Conversely, the functions of two or more units may be implemented by one physical device. This is true also in the case of a server and a computer.

### BRIEF DESCRIPTION OF DRAWINGS

The novel features of the present invention are set forth in the appended any one of claims. The invention itself, however, as well as other features and advantages thereof, will be best understood by reference to the detailed description of specific embodiments which follows, when read in conjunction with the accompanying drawings, wherein:

FIG. 1 is a view showing the overall configuration of an automatic access system in accordance with a first embodiment of the present invention.

FIG. 2(a) is a perspective external view for showing an example of a USB device 7 of FIG. 1. FIG. 2(b) is a schematic diagram for showing the electric configuration of the USB device 7 of FIG. 2(a). FIG. 2(c) is a schematic representation of programs and data stored in a ROM 27 incorporated in an MCU 21 of FIG. 2(b).

FIG. 3(a) is a schematic diagram for showing the electric configuration of a host computer 1 of FIG. 1. FIG. 3(b) is a schematic representation of the configuration of a storage area 71 of the host computer 1 of FIG. 1.

FIG. 4 is a schematic diagram for showing one example of the communication procedure among the USB device 7, a terminal 5, the host computer 1, and an WEB server W-k as illustrated in FIG. 1.

FIG. 5 is a view showing the overall configuration of a local barcode reader system in accordance with a second embodiment of the present invention.

FIG. 6(a) is a perspective external view for showing an example of a barcode reader 102 of FIG. 5. FIG. 6(b) is a schematic diagram for showing the electric configuration of the barcode reader 102 of FIG. 6(a).

FIG. 7 is a flow chart for showing the processing of an MCU 111 of FIG. 6(b).

FIG. 8 is a schematic diagram for showing one example of the communication procedure among the barcode reader 102, a terminal 5, a host computer 100, and a content server C-m of FIG. 5.

FIG. 9 is a view showing the overall configuration of a remote barcode reader system in accordance with a fourth embodiment of the present invention.

FIG. 10 is a schematic representation of the configuration of a storage area 81 of a center server 201 of FIG. 9.

FIG. 11 is a flow chart for showing an example of an authentication process in step S761 of FIG. 14.

FIG. 12 is a schematic diagram for showing one example of the communication procedure among a barcode reader 102, a terminal 5, a center server 201, and a content server C-m of FIG. 9 according to a modification example.

FIG. 13 is a flow chart for showing an example of an authentication process in step S341 of FIG. 12.

FIG. 14 is a flow chart for showing the processing of the center server 201 of FIG. 9 in accordance with the fourth embodiment.

FIG. 15 is a structural drawing for showing a barcode reader 107 in accordance with a fifth embodiment of the present invention.

FIG. 16 is a functional block diagram for showing the barcode reader 107 of FIG. 15.

FIG. 17 is an explanatory view for showing a barcode reading method of the barcode reader 107 of FIG. 15.

FIG. 18 is a view for showing examples of a barcode 104, pixel data P(t) at a predetermined location (n, m) in a frame picture 311, and binary data B(t) thereof.

FIG. 19 is a flow chart for showing the processing of an MCU 137 of FIG. 15.

### EXPLANATION OF REFERENCES

1, 100 . . . host computer, 5 . . . terminal, 7 . . . USB device, 9 . . . network, 11, 106 . . . database, 21, 111, 137 . . . MCU, 23, 112 . . . USB connector, 25 . . . USB port, 27 . . . ROM, 29 . . . program area, 31 . . . data area, 33, 157 . . . command, 35, 155 . . . URL, 37, 159 . . . serial number, 102, 107 . . . local barcode reader, 104 . . . barcode, 110 . . . scanner, W-0 to W-K (W-k) . . . WEB server, C-0 to C-M (C-m) . . . content server, 201 . . . center server, 209 . . . code database, 211 . . . URL database, 121 . . . housing, 123 . . . outgoing aperture, 131 . . . imaging element, 133, 130 . . . light emitting diode, 138 . . . substrate, 141 . . . USB cable, 119 . . . mouse button, 132 . . . switch, 165 . . . controlling unit, 167 . . . storage unit, 169 . . . mouse function unit, 171 . . . barcode decoder, 173 . . . light emitting unit, 175 . . . imaging unit, and 177 . . . transmitter.

### BEST MODE FOR CARRYING OUT THE INVENTION

In what follows, several embodiments of the present invention will be explained in detail with reference to the accompanying drawings. Meanwhile, like references indicate the same or functionally similar elements throughout the respective drawings, and therefore redundant explanation is not repeated.

### First Embodiment

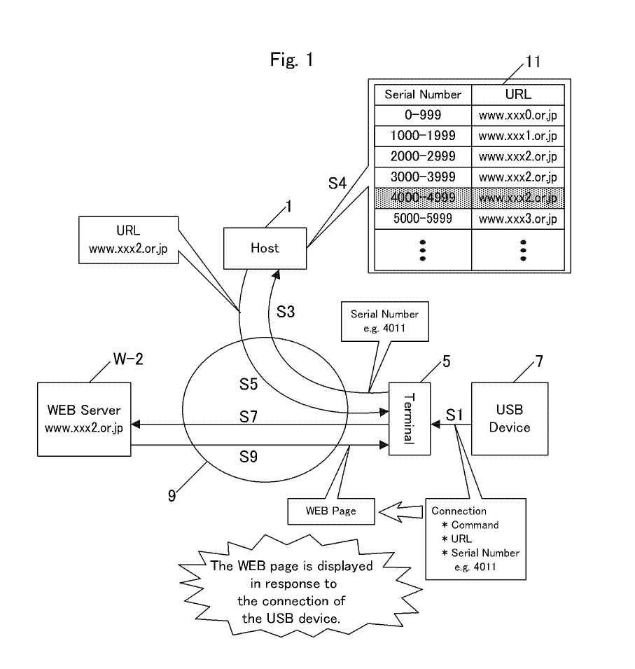

FIG. 1 is a view showing the overall configuration of an automatic access system in accordance with a first embodiment of the present invention. Referring to FIG. 1, a host computer 1, WEB servers W-0 to W-K (K is an integer) (only the WEB server W-2 is shown), and a terminal 5 are connected to a network 9 (e.g., Internet). Incidentally, the WEB servers W-0 to W-K may be collectively referred to as the WEB servers W-k.

By the way, in step S1, when a USB device 7 is connected to the terminal 5, the USB device 7 transmits a command, a serial number assigned to itself (e.g., number 4011), and a URL (Uniform Resource Locator) of the host computer 1 to the terminal 5. And, in step S3, the terminal 5 launches a browser in response to the command given by the USB device 7, accesses the host computer 1 on the basis of the URL given by the USB device 7, and transmits the serial number (e.g., number 4011) of the USB device 7 to the host computer 1.

The host computer 1 has a database 11 in which the serial numbers are related to the URL (www.xxx0.or.jp) of the WEB server W-0 to the URL (www.xxxK.or.jp) of the WEB server W-K. In step S4, the host computer 1 retrieves the URL (e.g., www.xxx2.or.jp) related to the serial number (e.g., number 4011) transmitted by the terminal 5 from the database 11. And, in step S5, the host computer 1 transmits the retrieved URL (e.g., www.xxx2.or.jp) to the terminal 5.

Then, in step S7, the terminal 5 accesses the WEB server W-k (e.g., the WEB server W-2) on the basis of the received URL (e.g., www.xxx2.or.jp) to request to send an WEB page. In step S9, the WEB server W-k (e.g., the WEB server W-2) transmits the WEB page to the terminal 5 in response to the request of the send. And, the terminal 5 displays the WEB page on a monitor (not shown in the figure).

By the above processes, when the USB device 7 is connected to the terminal 5, the browser is automatically launched, and then the WEB page, which is provided by the WEB server W-k corresponding to the serial number of the USB device 7, is displayed on the terminal 5. Incidentally, protocol (http://) is omitted in FIG. 1.

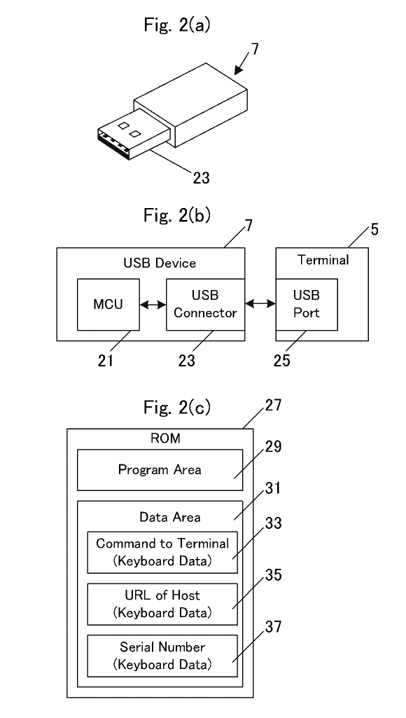

FIG. 2(a) is a perspective external view for showing an example of the USB device 7 of FIG. 1. FIG. 2(b) is a schematic diagram for showing the electric configuration of the USB device 7 of FIG. 2(a). FIG. 2(c) is a schematic representation of programs and data stored in a ROM 27 incorporated in an MCU 21 of FIG. 2(b).

Referring to FIG. 2(b), the USB device 7 of FIG. 2(a) is provided with an MCU (Micro Controller Unit) 21 and a USB connector 23. Also, the terminal 5 is provided with a USB port 25. The USB connector 23 of the USB device 7 is connected with the USB port 25 of the terminal 5, and thereby it is possible to perform the two-way communication between the USB device 7 and the terminal 5.

Referring to FIG. 2(c), the MCU 21 of the USB device 7 incorporates a ROM (Read Only Memory) 27. The ROM 27 includes a program area 29 and a data area 31. The program area 29 stores programs to be executed by the MCU 21. The data area 31 stores the command 33 to the terminal 5, the URL 35 of the host computer 1, and the serial number 37 assigned to the USB device 7 in the form of keyboard data.

Incidentally, actually, the serial number 37 is appended to the URL 35 of the host computer 1, and this is stored in the form of keyboard data. For example, it is assumed that the URL 35 is “http://www.ssd.co.jp” and the serial number 37 is “4011”, and data “http://www.ssd.co.jp/?sn=4011” is stored.

The command 33 is a command which is used to instruct the terminal 5 to run a browser and access the host computer 1 by the use of the URL 35. For example, in the case where the OS (Operating System) is Windows (registered trademark), the command 33 is provided as the keyboard data corresponding to a GUI (Graphical User Interface) key+“R” key of a keyboard if the OS is Windows 98 or latter version. Windows launches a browser (Internet Explorer) in response to this command 33. In other words, this command 33 is included as a default command of Windows which is an OS. Meanwhile, the GUI key of Windows is generally referred to as Windows key. Since the USB device 7 stores and outputs the command 33 of an OS such as Windows which is taking a significant market share, it is possible to make use of most terminals as the terminal 5 for the present system by an easy procedure, i.e., only by connecting the USB device 7 to the terminal 5. Because of this, the USB device 7 need not store a plurality of commands in advance, and recognize the OS used by each terminal 5, select and use one of the commands, and so forth.

The serial number 37 is a unique number that is assigned to identify the USB device 7, and may be referred to as identification information.

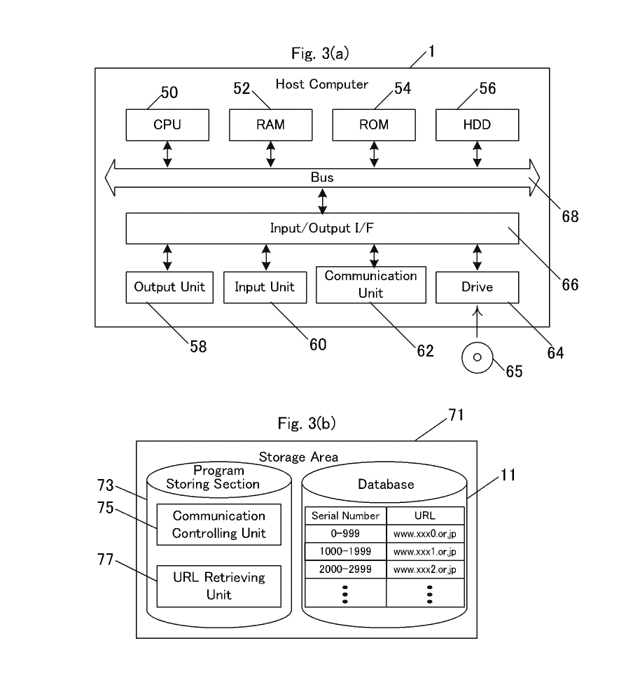

FIG. 3(a) is a schematic diagram for showing the electric configuration of the host computer 1 of FIG. 1. Referring to FIG. 3(a), the host computer 1 includes a CPU (Central Processing Unit) 50, a RAM (Random Access Memory) 52, a ROM 54, a HDD (Hard Disk Drive) 56, an input/output interface (input/output I/F) 66, an output unit 58, an input unit 60, a communication unit 62, a drive 64 and a bus 68.

The CPU 50 is connected to the RAM 52, the ROM 54, the HDD 56, and the input/output I/F 66 through the bus 68. The input/output I/F 66 is connected to the output unit 58 such as an LCD display, the input unit 60 such as a mouse or a keyboard, the communication unit 62 such as a LAN card or a USB controller serving to make a connection with the network 9, and the drive 64 for driving a removable recording medium 65 such as CD-ROM, DVD-ROM, respectively.

Incidentally, the hardware configurations of the terminal 5 and the WEB server W-k are similar to the hardware configuration of the host computer 1, and therefore no redundant description is repeated.

FIG. 3(b) is a schematic representation of the configuration of a storage area 71 of the host computer 1. As shown in FIG. 3(b), the storage area 71 of the HDD 56 and the ROM 54 of the host computer 1 includes a program storing section 73 and a database 11. A database 11 is a database in which the serial numbers of the USB devices 7 are related to the URL (www.xxx0.or.jp) of the WEB server W-0 to the URL (www.xxxK.or.jp) of the WEB server W-K. A communication controlling unit 75 of the program storing section 73 serves to communicate with a computer connected to the network 9 through the communication unit 62. Also, a URL retrieving unit 77 accesses the database with the serial number of the USB device 7 received from the terminal 5 as an index to retrieve the URL related to the serial number. These function units are implemented as programs of computer software, or subroutines of a program installed in the ROM 54 and/or the HDD 56. These programs are stored in the removable recording medium 65, and installed in the host computer 1 therefrom.

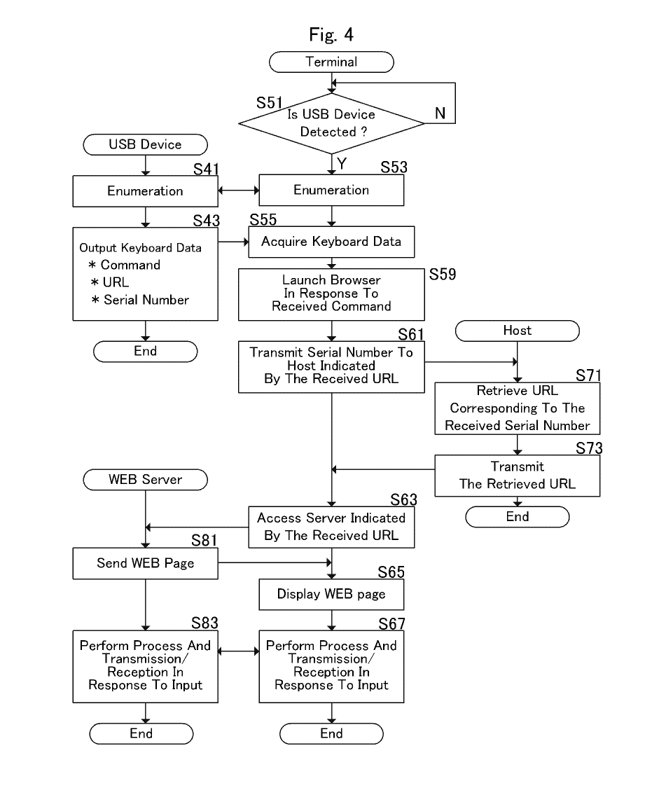

FIG. 4 is a schematic diagram for showing one example of the communication procedure among the USB device 7, the terminal 5, the host computer 1, and the WEB server w-k as illustrated in FIG. 1. Referring to FIG. 4, in step S51, the terminal 5 checks whether or not the USB device 7 has connected thereto, the process proceeds to step S53 if the connection of the USB device is detected, otherwise the process returns to step S51.

In steps S53 and S41, the terminal 5 and the MCU 21 of the USB device 7 communicate with each other, and the terminal 5 performs the enumeration. A descriptor is given from the MCU 21 to the terminal 5 by the enumeration, and the terminal 5 parses the descriptor to recognize the configuration of the USB device 7. The terminal 5 recognizes that the USB device 7 is a keyboard by the enumeration.

In step S55, the terminal 5 receives the keyboard data (the command 33, the URL 35, and the serial number 37) sent by the MCU 21 in step S43. Then, the terminal 5 launches the browser in response to the command 33 sent from the MCU 21 in step S59, and accesses the host computer 1 with reference to the URL sent from the USB device 7 in step S61. At this time, the URL 35 to which the serial number 37 is appended is transmitted to the host computer 1.

The host computer 1 then receives the URL 35 to which the serial number 37 is appended. And, in step S71, the host computer 1 accesses the database 11 with the received serial number 37 as an index to retrieve the URL related to the serial number 37. In step S73, the host computer 1 transmits the URL as retrieved in step S71 to the terminal 5, and instructs to access the URL.

In step S63, the terminal 5 accesses the WEB server W-k addressed by the received URL to request to send the WEB page. Then, in step S81, the WEB server W-k sends the WEB page to the terminal 5. And, in step S65, the terminal 5 displays the WEB page on the monitor.

In step S67, the terminal 5 performs processing and communication with the WEB server W-k in response to the input operation by the user. Likewise, in step S83, the WEB server W-k performs processing and communication with the terminal 5 in response to the access from the terminal 5.

Next is a supplementary explanation of step S61. More specifically, in step S61, the terminal 5 accesses a DNS (Domain Name System) server, acquires an IP address corresponding to a domain name, transmits the URL 35 to which the serial number 37 is appended to the network 9 together with the IP address, and transmits the serial number 37 to the host computer 1 by accessing the host computer 1. However, detailed description of the above processing is dispensed with because these steps are performed by well-known protocols. This is true also in the case of the step S63.

By the way, as described above, in accordance with the present embodiment, the terminal 5 to which the USB device 7 is connected accesses the host computer 1 firstly to transmit the serial number of the USB device 7. That is, the terminal 5 passes through the host computer 1 absolutely instead of accessing the WEB servers W-0 to W-K directly. Accordingly, the host computer 1 can determine the WEB server to be accessed by the terminal 5 from among the plurality of the WEB servers W-0 to W-K in accordance with the serial number. That is, even after the delivery of the USB device 7 (including a period after the USB device 7 is distributed to the end-user), the host computer 1 can determine, only by changing the URL (of the WEB server W-k) to which the serial number of the USB device 7 is related in the database 11, the destination of the automatic access of the terminal 5 to which the USB device 7 is connected. In this way, it is possible to subsequently determine the destination of the automatic access of the terminal 5 to which the USB device 7 is connected, and therefore it is convenient.

In the case where it is possible to subsequently determine the destination of the automatic access of the terminal 5 to which the USB device 7 is connected, examples of the advantage thereof will be described.

Since the URL which is preliminarily stored in the USB device 7 is not the URL of the WEB server W-k but the URL of the host computer 1, the URL is not given by an orderer of the USB device 7, and the destination of the automatic access can be subsequently determined. Accordingly, it is possible to preliminarily mass-produce the USB devices 7 in advance of order entry. As the result, a large number of order receivers can benefit from the cost reduction from the beginning.

In passing, as conventionally, in the case where an WEB page is directly displayed by a URL stored in a USB device, since the orderer assigns the URL to be stored in the USB device, the production is completely the made-to-order production. That is, the URL to be stored in the USB device is not determined until an order. In this way, since the production depends on the actual order entry, it is impossible to preliminarily mass-produce the USB devices in advance of the order entry.

Besides, even after the USB device 7 is distributed to the end-user, the host computer 1 can dynamically change, only by changing the URL (of the WEB server W-k) to which the serial number of the USB device 7 is related in the database 11, i.e., only by rewriting the data in the database 11, the destination of the automatic access without accessing the terminal 5 and the USB device 7 of the end-user. For example, it is assumed that a rewritable memory such as an EEPROM is incorporated in a USB device, a URL (of the WEB server W-k) is written in the memory, and then the URL is rewritten. However, in this case, since a host computer needs to access a terminal and the USB device of an end-user, the user may be anxious about security and therefore refuse the rewriting, and the large labor hour is imposed on the user and the host computer. Also, for example, it is assumed that a URL of the WEB server W-0 is stored in a USB device. In this case, in the case where leading to the WEB server W-2 other than the WEB server W-0 is desired, it is required to assign the URL stored in the USB device to the WEB server W-2, and change or close the URL of the WEB server W-0, and therefore it is not convenient.

In the present embodiment, since the URL and the serial number, i.e., the WEB server W-k and the USB device 7 are one-on-one related to each other, it is possible to distribute the USB devices 7 as dedicated USB devices for an operating entity running the WEB server W-k. In addition, in the case where the operating entity desires to lead to another WEB server, it is possible to lead to the another WEB server only by relating the serial numbers of the USB devices 7 distributed as the dedicated USB devices for the operating entity to the URL of the another WEB server in the database 11 without newly distributing USB devices V.

Also, in the present embodiment, since the USB device 7 is recognized as a keyboard by the terminal 5, it is possible to send the serial number, the URL, and the command in the form of the keyboard data to the terminal 5, and the command which the USB device 7 sends to the terminal 5 is a command to the operating system. Thus, it is possible to use the function of the operating system of the terminal 5 as it is. As the result, it is not required for the terminal 5 to install dedicated software by realizing the automatic access to the host computer 1 using the function of the operating system of the terminal 5, and therefore it is possible to improve the convenience of the user.

Further, in the present embodiment, a USB-compliant device, i.e., the USB device 7 is employed. In this way, since the USB of a widely diffused interface standard is employed, more end-users can easily use the present system.

By the way, a usage example of the USB device 7 according to the present embodiment will be described. As advertising media of a specified company, the USB devices 7 of FIG. 2(a) are distributed to a large number of consumers free of cost. In this case, the serial numbers assigned to the USB devices 7 as distributed free of cost are, in the database 11, related to the URL of the WEB server W-k which the specified company runs. When a consumer who receives the distribution connects the USB device 7 to any terminal 5, the WEB server W-k run by the specified company automatically transmits the WEB page to the terminal 5. In this way, the specified company can directly lead the consumer to the website managed by the specified company itself. On the other hand, since the consumer who receives the distribution can browses the WEB page only by connecting the USB device 7 to the terminal 5, it is convenient.

As shown in this example, in the case where it is intended to advertise, since it is required to distribute to a large number of consumers as much as possible free of cost, the cost of the USB device 7 is the large problem. However, in the present embodiment, as described above, it is easy to reduce the cost by the mass production of the USB devices 7, and therefore it is suitable for usage with the above intent.

### Second Embodiment

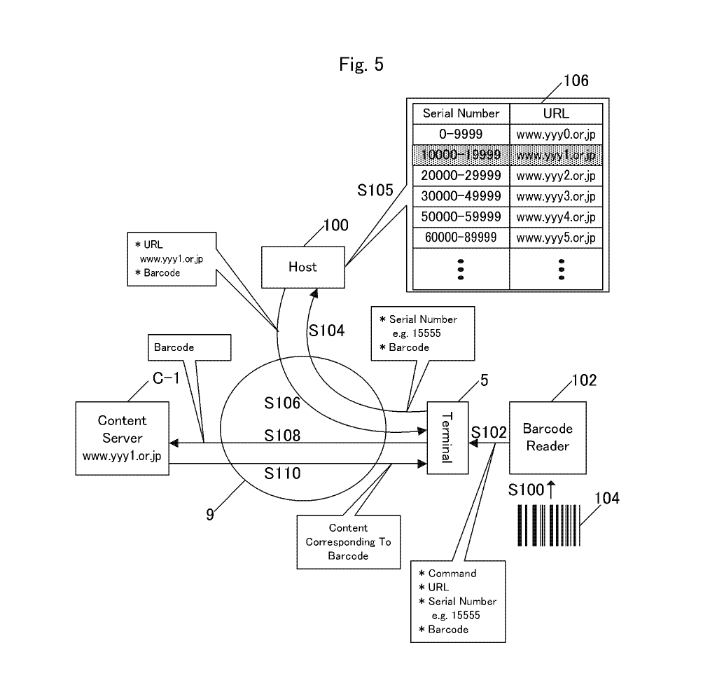

FIG. 5 is a view showing the overall configuration of a local barcode reader system in accordance with the second embodiment of the present invention. Referring to FIG. 5, a host computer 100, content servers C-0 to C-M (M is an integer) (only the content server C-1 is shown), and a terminal 5 are connected to a network 9 (e.g., Internet). Incidentally, the content servers C-0 to C-M may be collectively referred to as the content servers C-m.

By the way, in step S100, a local barcode reader 102 (may simply be referred to as a barcode reader 102) scans and decodes a barcode 104 in response to user's operation, and acquires barcode information. Then, in step S102, the barcode reader 102 transmits a command, a URL of the host computer 100, a serial number assigned to itself (e.g., number 15555), and the barcode information to the terminal 5.

In step S104, the terminal 5 launches the browser in response to the command received from the barcode reader 102, and accesses the host computer 100 with reference to the URL received from the barcode reader 102 to transmit the barcode information and the serial number (e.g., number 15555) to the host computer 100.

The host computer 100 has a database 106 in which the serial numbers are related to the URL (www.yyy0.or.jp) of the content server C-0 to the URL (www.yyyM.or.jp) of the content server C-M. In step S105, the host computer 100 retrieves the URL (e.g., www.yyy1.or.jp) related to the serial number (e.g., number 15555) transmitted by the terminal 5 from the database 106. And, in step S106, the host computer 100 transmits the retrieved URL (e.g., www.yyy1.or.jp) to the terminal 5 together with the barcode information received from the terminal 5.

Then, in step S108, the terminal 5 accesses the content server C-m (e.g., the content server C-1) with reference to the received URL (e.g., www.yyy1.or.jp) to transmit the barcode information received from the host computer 100 to the content server C-1. In step S110, the content server C-m (e.g., the content server C-1) performs the processing in accordance with the received barcode information, and transmits the content in accordance with the barcode information to the terminal 5. Then, the terminal 5 displays the received content on a monitor (not shown in the figure).

By the above processes, when the barcode reader 102 connected to the terminal 5 scans the barcode 104, the browser of the terminal 5 is automatically launched, and then the barcode information is transmitted to the content server C-m corresponding to the serial number of the barcode reader 102. And, the content server C-m corresponding to the serial number of the barcode reader 102 provides the terminal 5 with the content in accordance with the barcode information. The term “content” is used as a term including not only a content itself but also data and information defining the content.

Incidentally, protocol (http://) is omitted in FIG. 5. Also, the hardware configurations of the host computer 100 and the content server C-m are similar to the hardware configuration of the host computer 1 of FIG. 3(a).

Also, since the local barcode reader system displays the content on the terminal 5 in response to the scan of the barcode 104 by the barcode reader 102, it may be referred to as an automatic access system.

Besides, the barcode reader 102 may be for example a pen scanner, a CCD touch scanner, a handheld laser scanner, a desktop laser scanner, a slot reader, or any other type and shape of barcode reader.

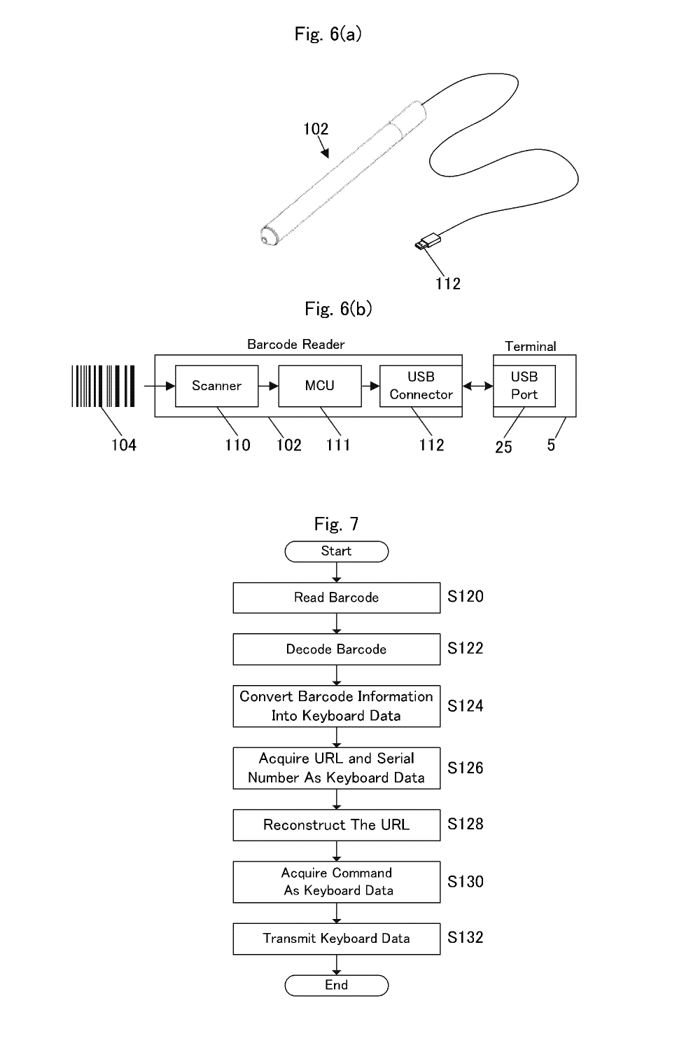

FIG. 6(a) is a perspective external view for showing an example of the barcode reader 102 of FIG. 5. FIG. 6(b) is a schematic diagram for showing the electric configuration of the barcode reader 102 of FIG. 6(a). Referring to FIG. 6(a), the barcode reader 102 is a pen type USB barcode reader. Referring to FIG. 6(b), the barcode reader 102 includes a scanner 110, an MCU 111 and a USB connector 112. The scanner 110 optically reads a barcode 104, and converts (scans) bars and spacings into an electrical signal. The electrical signal corresponding to the barcode 104 is given to the MCU 111 from the scanner 110, and the MCU 111 decodes the electrical signal and acquires the barcode information. Also, the USB connector 112 of the barcode reader 102 is connected with the USB port 25 of the terminal 5, and thereby it is possible to perform the two-way communication between the MCU 111 and the terminal 5.

In this case, the configuration of the MCU 111 is similar to the configuration of the MCU 21 of FIG. 2(b). Accordingly, the MCU 111 incorporates a ROM (Read Only Memory). The ROM includes a program area and a data area in a manner similar to the ROM 27 of FIG. 2(c). The program area stores programs to be executed by the MCU 111. The data area stores a command to the terminal 5, a URL of the host computer 100, and a serial number assigned to the barcode reader 102 in the form of keyboard data. The command is a command which is used to instruct the terminal 5 to run a browser and access the host computer 100 by the use of the URL, and is similar to the command 33. The serial number is a unique number that is assigned to identify the barcode reader 102, and may be referred to as identification information.

FIG. 7 is a flow chart for showing the processing of the MCU 111 of FIG. 6(b).

Referring to FIG. 7, in step S120, the MCU 111 of the barcode reader 102 reads the barcode 104 in response to the operation of a user. In step S122, the MCU 111 decodes the barcode on the basis of a known barcode decoding technique to acquire the barcode information. In step S124, the MCU 111 converts the barcode information (e.g., “4560256580016”) which is the result of decoding into keyboard data, and stores the keyboard data in the RAM (not shown in the figure).

In step S126, the MCU 111 acquires the URL of the host computer 100 (for example, “http://www.ssd.co.jp”) and the serial number (for example, “15555”) from the ROM (not shown in the figure) as keyboard data. Then, in step S128, the MCU 111 appends the barcode information and the serial number as keyboard data to the end of the URL as acquired, and stores it in the RAM (not shown in the figure) as a new URL (for example, “http://www.ssd.co.jp/?bc=4560256580016&sn=15555”).

In step S130, the MCU 111 acquires the command from the ROM (not shown in the figure) in the form of keyboard data, and stores the command in the RAM (not shown in the figure). In step S132, the MCU 111 transmits the keyboard data (the command 57 and the URL (the command, the URL, the serial number, and the barcode information) of steps S124 to S130 to the terminal 5, and then ends the processing.

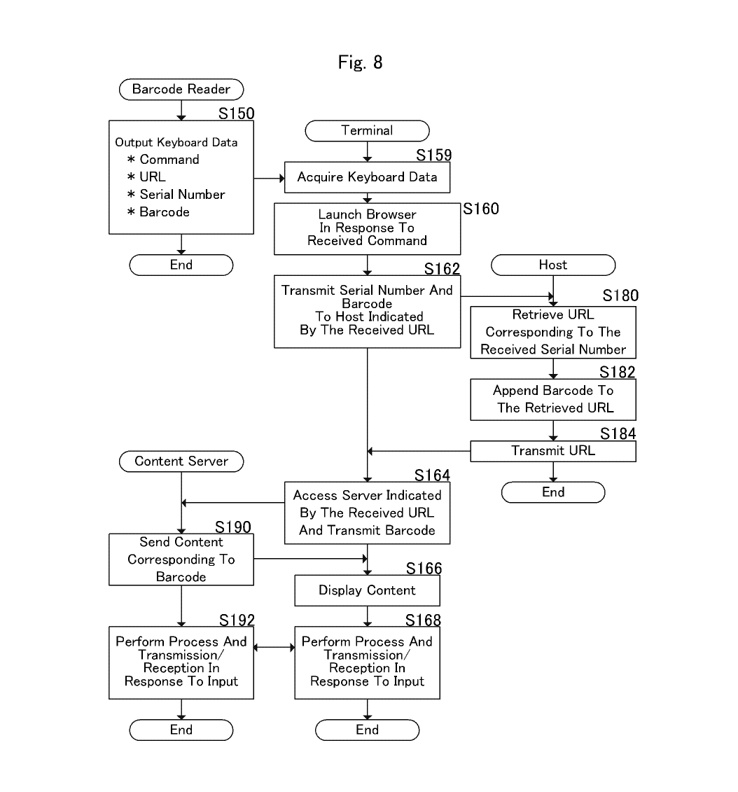

FIG. 8 is a schematic diagram for showing one example of the communication procedure among the barcode reader 102, the terminal 5, the host computer 100, and the content server C-m of FIG. 5. Referring to FIG. 8, in step S150, the barcode reader 102 transmits the keyboard data as generated in the processes of FIG. 7 (the command, the URL, the serial number, and the barcode information) to the terminal 5.

In step S159, the terminal 5 receives the keyboard data (the command, the URL, and the serial number) transmitted by the MCU 111 in step S150. Then, the terminal 5 launches the browser in response to the command transmitted from the MCU 111 in step S160, and accesses the host computer 100 with reference to the URL transmitted from the MCU 111 in step S162. At this time, the URL to which the serial number and the barcode information are appended is transmitted to the host computer 100.

Then, the host computer 100 receives the URL to which the serial number and the barcode information are appended. And, in step S180, the host computer 100 accesses the database 106 with the received serial number as an index to retrieve the URL related to the serial number. In step S182, the host computer 100 appends the barcode information to the retrieved URL. And, in step S184, the host computer 100 transmits the URL to which the barcode information is appended to the terminal 5, and instructs to access the URL.

In step S164, the terminal 5 accesses the content server C-m addressed by the received URL, and transmits the URL to which the barcode information is appended. Then, in step S190, the content server C-m performs the processing in accordance with the received barcode information, and transmits the content in accordance with the barcode information to the terminal 5. And, in step S166, the terminal 5 displays the content on the monitor.

In step S168, the terminal 5 performs processing and communication with the content server C-m in response to the input operation by the user. Likewise, in step S192, the content server C-m performs processing and communication with the terminal 5 in response to the access from the terminal 5.

Incidentally, also in steps S162 and S164, like the step S61 of FIG. 4 as described above, the well-known protocols are applied, and therefore the detailed description is dispensed.

By the way, as described above, the terminal 5, to which command, the barcode information, the serial number, and the URL of the host computer 100 are sent by the barcode reader 102, firstly accesses the host computer 100 with reference to the URL in response to the command, and transmits the serial number and the barcode information. That is, the terminal 5 passes through the host computer 100 absolutely instead of accessing the content servers C-0 to C-M directly. Accordingly, the host computer 100 can determine the server to be accessed by the terminal 5 from among the plurality of the content servers C-0 to C-M in accordance with the serial number. That is, even after the delivery of the barcode reader 102 (including a period after the barcode reader 102 is distributed to the end-user), the host computer 100 can determine, only by changing the URL (of the content server C-m) to which the serial number of the barcode reader 102 is related in the database 106, the destination of the automatic access of the terminal 5 to which the barcode reader 102 is connected. In this way, it is possible to subsequently determine the destination of the automatic access of the terminal 5 to which the barcode reader 102 is connected, and therefore it is convenient.

In the case where it is possible to subsequently determine the destination of the automatic access of the terminal 5 to which the barcode reader 102 is connected, examples of the advantage thereof will be described.

Since the URL which is preliminarily stored in the barcode reader 102 is not the URL of the content server C-m but the URL of the host computer 100, the URL is not given by an orderer of the barcode reader 102, and the destination of the access can be subsequently determined. Accordingly, it is possible to preliminarily mass-produce the barcode readers 102 in advance of order entry. As the result, a large number of order receivers can benefit from the cost reduction from the beginning.

Also, even after the barcode reader 102 is distributed to the end-user, the host computer 100 can dynamically change, only by changing the URL (of the content server C-m) to which the serial number of the barcode reader 102 is related in the database 106, i.e., only by rewriting the data in the database 106, the destination of the automatic access without accessing the terminal 5 and the barcode reader 102 of the end-user.

In the present embodiment, since the URL and the serial number, i.e., the content server C-m and the barcode reader 102 are one-on-one related to each other, it is possible to distribute the barcode readers 102 as dedicated barcode readers for an operating entity running the content server C-m. In addition, in the case where the operating entity desires to lead to another content server, it is possible to lead to the another WEB server only by relating the serial numbers of the barcode readers 102 distributed as the dedicated barcode readers 102 for the operating entity to the URL of the another content server in the database 106 without newly distributing barcode readers 102.

Further, in the present embodiment, the terminal 5, i.e., the user can receive the content provided corresponding to the barcode information read by the barcode reader 102 from the content server C-m addressed by the URL sent from the host computer 100.

Still further, in the present embodiment, since the barcode reader 102 is recognized as a keyboard by the terminal 5, it is possible to send the barcode, the serial number, the URL, and the command in the form of the keyboard data to the terminal 5, and the command which the barcode reader 102 sends to the terminal 5 is a command to the operating system. Thus, it is possible to use the function of the operating system of the terminal 5 as it is. As the result, it is not required for the terminal 5 to install dedicated software by realizing the automatic access to the host computer 100 using the function of the operating system of the terminal 5, and therefore it is possible to improve the convenience of the user.

Still further, in the present embodiment, the barcode reader 102 conforms to the USB. In this way, since the USB of a widely diffused interface standard is employed, more end-users can easily use the present system.

### Third Embodiment

The third embodiment is a combination of the first embodiment and the second embodiment. Accordingly, the third embodiment has the same advantages as the first and second embodiments.

That is, the third embodiment employs the barcode reader 102 according to the second embodiment in place of the USB device 7 in the first embodiment. Thereby, in response to that the barcode reader 102 is connected to the terminal 5, a content with which the content server C-m related to the serial number of the barcode reader 102 provides is automatically displayed on the terminal 5. These processes are similar to the processes in the first embodiment. That is, in the description about FIG. 4, the MCU 21 of the USB device 7 is replaced by the MCU 111 of the barcode reader 102, the host computer 1 is replaced by the host computer 100, the WEB server W-k is replaced by the content server C-m, and the database 11 is replaced by the database 106.

Subsequently, the processes after the barcode reader 102 scans the barcode 104 are the same as the second embodiment.

Incidentally, a host computer to be accessed when the barcode reader 102 is connected to the terminal 5 may be different from a host computer to be accessed when the barcode 104 is scanned, i.e., two URLs may be stored in the barcode reader 102, and a content server to be accessed in the former case may be different from a content server to be accessed in the latter case. Needless to say, the same host computer may be accessed in both the former and latter while the content server to be accessed in the former case may be different from the content server to be accessed in the latter case.

### Fourth Embodiment

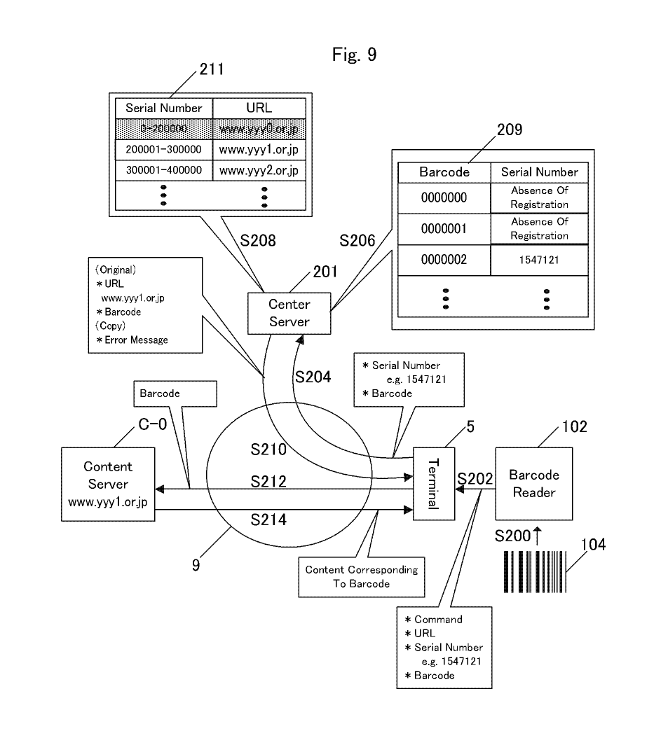

FIG. 9 is a view showing the overall configuration of a remote barcode reader system in accordance with the fourth embodiment of the present invention. Incidentally, protocol (http://) is omitted in FIG. 9. Referring to FIG. 9, a center server 201, content servers C-0 to C-M (M is an integer) (only the content server C-0 is shown), and a communication terminal 5 are connected to a network 9 (e.g., Internet). Incidentally, the content servers C-0 to C-M may be collectively referred to as the content servers C-m.

By the way, in step S200, a local barcode reader 102 (may simply be referred to as a barcode reader 102) scans and decodes a barcode 104 in response to user's operation, and acquires barcode information. Then, in step S202, the barcode reader 102 transmits a command, a URL (Uniform Resource Locator) of the center server 201, a serial number assigned to itself (e.g., number 1547121), and the barcode information to the terminal 5.

In step S204, the terminal 5 launches the browser in response to the command received from the barcode reader 102, and accesses the center server 201 with reference to the URL received from the barcode reader 102 to transmit the barcode information and the serial number to the center server 201.

The center server 201 has a code database 209 in which the barcode information is related to the serial numbers. In step S206, the center sever 201 retrieves the received barcode information from the code database 209.

And, if a serial number is registered relating to the retrieved barcode information and furthermore the serial number is consistent with the received serial number, or if a serial number is not registered relating to the retrieved barcode information, the center server 201 regards the barcode 104 as an original barcode and proceeds to the next step S208 so as to provide with service by the present system.

On the other hand, if a serial number is registered relating to the retrieved barcode information and furthermore the serial number is inconsistent with the received serial number, the center server 201 regards the barcode 104 as a copy of an original barcode, refuses to provide with the service by the present system, and sends an error message to the terminal 5.

The center server 201 has a URL database 211 in which the serial numbers are related to the URLs (www.yyy0.or.jp˜www.yyyM.or.jp) of the content servers C-0 to C-M. In step S208, the center server 201 retrieves the URL (e.g., www.yyy0.or.jp) related to the serial number (e.g., number 1547121) transmitted by the terminal 5 from the URL database 211. And, in step S210, the center server 201 transmits the retrieved URL to the terminal 5 together with the barcode information received from the terminal 5.

Then, in step S212, the terminal 5 accesses the content server C-m (e.g., the content server C-0) with reference to the received URL (e.g., www.yyy0.or.jp) to transmit the barcode information received from the center server 201 to the content server C-m. In step S214, the content server C-m performs the processing in accordance with the received barcode information, and transmits the content in accordance with the barcode information to the terminal 5. Then, the terminal 5 displays the received content on a monitor (not shown in the figure).

In this case, the barcode reader 102 of FIGS. 6(a) and 6(b) can be employed as the barcode reader 102 of FIG. 9. However, the URL to be stored in the ROM of the MCU 111 is the URL of the center server 201 in the form of the keyboard data, and the command to be stored in the ROM is the command for instructing to access the center server 201 in the form of the keyboard data.

Also, the electric configurations of the center server 201 and the content server C-m of FIG. 9 are similar to the electric configuration of the host computer 1 of FIG. 3(a).

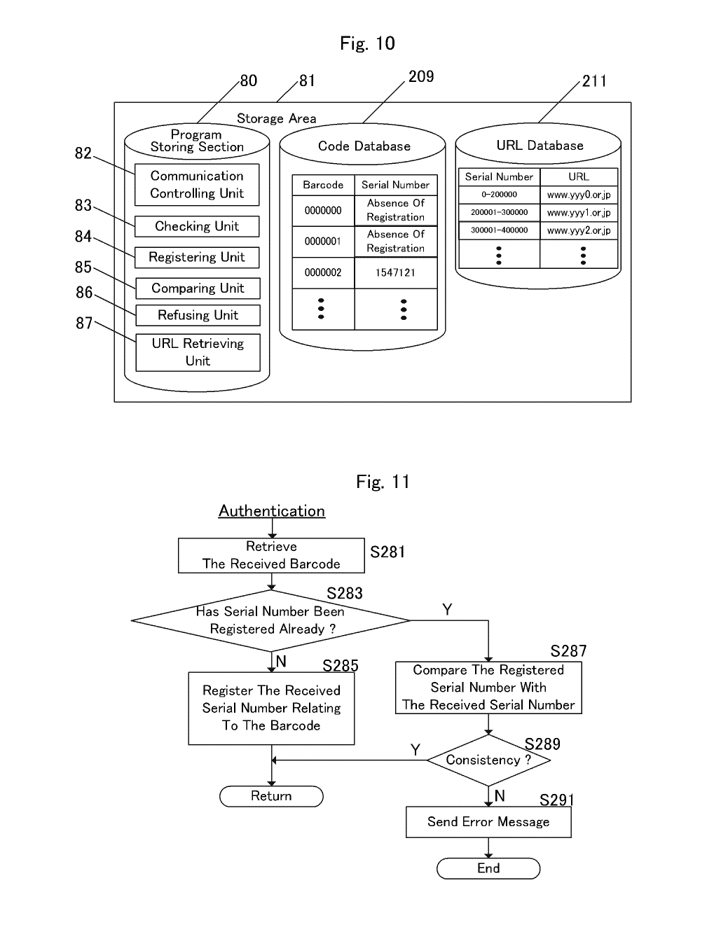

FIG. 10 is a schematic representation of the configuration of a storage area 81 of the center server 201. As shown in FIG. 10, the storage area 81 of the HDD 56 and the ROM 54 (see FIG. 3(a)) of the center server 201 includes a program storing section 80, the code database 209, and the URL database 211. The code database 209 is a database in which the barcodes 104 are related to the serial numbers of the barcode readers 102. The URL database 211 is a database in which the serial numbers of the barcode readers 102 are related to the URLs (www.yyy0.or.jp˜www.yyyM.or.jp) of the content servers C-0 to C-M.

A communication controlling unit 80 of the program storing section 80 serves to communicate with a computer connected to the network 9 through the communication unit 62. A checking unit 83 accesses the code database 209, and checks whether or not the serial number is registered relating to the received barcode 104. And, as the result of the check by the checking unit 83, if the serial number is not registered, a registering unit 84 registers relating the received serial number to the received barcode 104 in the code database 209.

As the result of the check by the checking unit 83, if the serial number is registered, a comparing unit 85 compares the serial number registered relating to the received barcode 104 with the received serial number. If the serial number is not registered relating to the received barcode 104 as the result of the check by the checking unit 83, or if the registered serial number is consistent with the received serial number as the result of the comparison by the comparing unit 85, a URL retrieving unit 87 accesses the URL database 211 with the serial number of the barcode reader 102 received from the terminal 5 as an index, retrieves the URL related to the serial number, and transmits the URL and the barcode to the terminal 5 through the communication controlling unit 82.

As the result of the comparison by the comparing unit 85, if the registered serial number is inconsistent with the received serial number, a refusing unit 86 refuses to provide with the service by the present system, and sends the error message to the terminal 5 through the communication controlling unit 82 irrespective of the received barcode 104.

These function units are implemented as programs of computer software, or subroutines of a program installed in the ROM 54 and/or the HDD 56. These programs are stored in the removable recording medium 65, and installed in the center server 201 therefrom.

By the way, the process flow by the MCU 111 (see FIG. 6(b)) of the barcode reader 102 according to the present embodiment is similar to the process flow shown by the flowchart of FIG. 7, and therefore no redundant description is repeated.

Also, in the present embodiment, the communication procedure among the barcode reader 102, the terminal 5, the center server 201, and the content server C-m is similar to the communication procedure shown in FIG. 8. However, in the description about FIG. 8, the host computer 100 is replaced by the center server 201. Also, the center server 201 performs not the processing shown in FIG. 8 but the processing shown in FIG. 14.

Referring to FIG. 14, when the center server 201 receives the URL to which the serial number and the barcode information are appended from the terminal 5, in step S761, the center server 201 performs the authentication process of the barcode 104 on the basis of the serial number and the barcode information. Then, if it is authenticated that the barcode 104 is original, in step S763, the center server 201 accesses the URL database 211 with the received serial number as an index to retrieve the URL assigned to the serial number. In step S765, the center server 201 appends the barcode information to the retrieved URL. And, in step S767, the center server 201 transmits the URL to which the barcode information is appended to the terminal 5, and instructs to access the URL.

FIG. 11 is a flow chart for showing an example of the authentication process in step S761 of FIG. 14. Referring to FIG. 11, in step S281, the center server 201 retrieves the received barcode information from the code database 209. In step S283, the center server 201 determines whether or not the serial number is registered relating to the retrieved barcode information, the process proceeds to step S285 if it is not registered, conversely the process proceeds to step S287 if it is registered.

In step S285, the center server 201 registers relating the received barcode information to the received serial number in the code database 209, and then returns. That is, if the serial number is not registered relating to the received barcode (“NO” in step S283), it is regarded that the barcode is sent from the initial purchase user and therefore is original, the received serial number is registered relating to the barcode in the code database 209, and furthermore the process proceeds to step S63 so as to provide with the service by the present system.

On the other hand, in step S287, the center server 201 compares the serial number registered relating to the barcode in the code database 209 with the received serial number. And, in step S289, the center server 201 regards the barcode as original one if both are consistent, and proceeds to step S63 so as to provide with the service by the present system. However, if both are inconsistent, the center server 201 regards that the barcode is copied one transmitted from a person other than an initial purchase user, and proceeds to step S291 where the error message is sent to the terminal 5 irrespective of the barcode. Accordingly, it is possible to weed out use of an unauthorized copy of an original barcode as much as possible.

### Modification Example

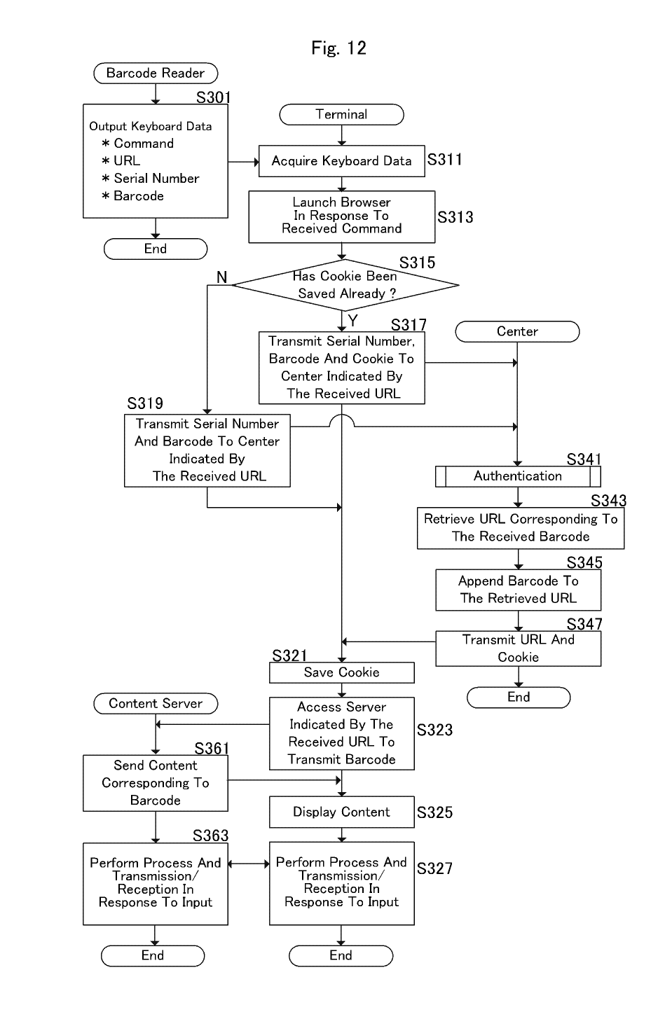

FIG. 12 is a schematic diagram for showing one example of the communication procedure among the barcode reader 102, the terminal 5, the center server 201, and the content server C-m of FIG. 9 according to the modification example. Referring to FIG. 12, in step S301, the barcode reader 102 transmits the keyboard data as generated in the processes of FIG. 7 (the command, the URL, the serial number, and the barcode information) to the terminal 5.

In step S311, the terminal 5 receives the keyboard data (the command, the URL, and the serial number) transmitted by the barcode reader 102 in step S301. In step S313, the terminal 5 launches the browser in response to the command transmitted from the barcode reader 102. Then, in step S315, the terminal 5 determines whether or not cookie information sent from the center server 201 is saved, the process proceeds to step S317 if it is saved, conversely the process proceeds to step S319 if it is not saved.

In step S317, the terminal 5 accesses the center server 201 with reference to the URL transmitted from the barcode reader 102. At this time, the cookie information and the URL to which the serial number and the barcode information are appended are transmitted to the center server 201. On the other hand, in step S319, the terminal 5 accesses the center server 201 with reference to the URL transmitted from the barcode reader 102. At this time, the URL to which the serial number and the barcode information are appended is transmitted to the center server 201.

The center server 201 receives the cookie information and the URL to which the serial number and the barcode information are appended, which are transmitted in step S317, or the center server 201 receives the URL to which the serial number and the barcode information are appended, which is transmitted in step S319.

Then, in step S341, the center server 201 performs the authentication process of the barcode 104 on the basis of the barcode information and the cookie information. If it is authenticated that the barcode 104 is original, in step S343, the center server 201 accesses the URL database 211 with the received serial number as an index to retrieve the URL related to the serial number. In step S345, the center server 201 appends the barcode information to the retrieved URL. And, in step S347, the center server 201 transmits the cookie information and the URL to which the barcode information is appended to the terminal 5, and instructs to access the URL.

In step S321, the terminal 5 saves the received cookie information. In step S323, the terminal 5 accesses the content server C-m addressed by the received URL, and transmits the URL to which the barcode information is appended. Then, in step S361, the content server C-m performs the processing in accordance with the received barcode information, and transmits the content in accordance with the barcode information to the terminal 5. And, in step S325, the terminal 5 displays the content on the monitor.

In step S327, the terminal 5 performs processing and communication with the content server C-m in response to the input operation by the user. Likewise, in step S363, the content server C-m performs processing and communication with the terminal 5 in response to the access from the terminal 5.

Incidentally, also in steps S317 and S323, the well-known protocols are applied, and therefore the detailed description is dispensed.

Incidentally, in advance of the detailed description about step S341, a code database employed in the modification example will be described. The code database is a database in which the barcode information is related to the identification information (ID) of the terminal 5. As described below, the identification information of the terminal 5 is generated by the center server 201.

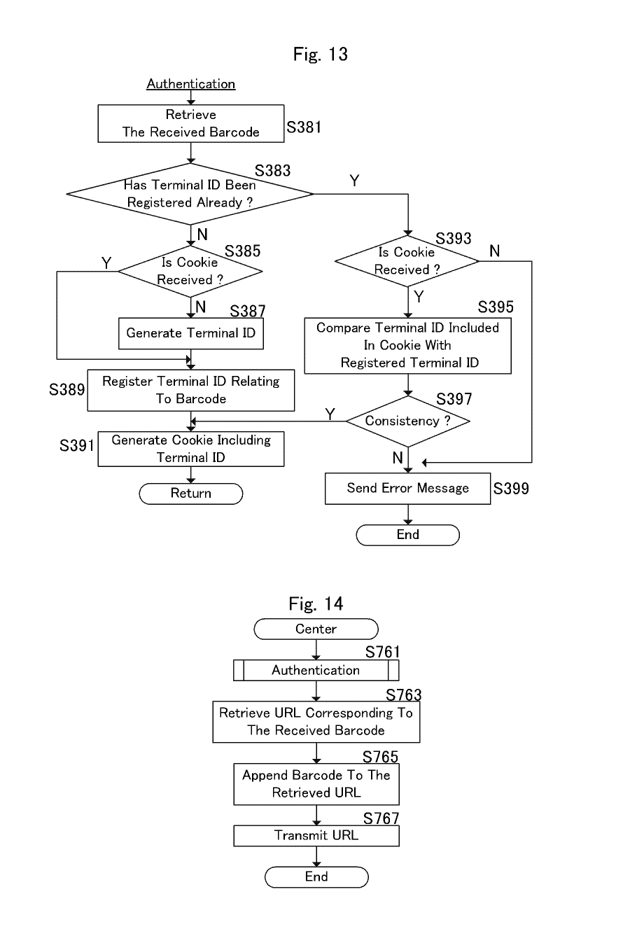

FIG. 13 is a flow chart for showing an example of the authentication process in step S341 of FIG. 12. Referring to FIG. 13, in step S381, the center server 201 retrieves the received barcode information from the code database. In step S383, the center server 201 determines whether or not the identification information of the terminal 5 is registered relating to the retrieved barcode information, the process proceeds to step S385 if it is not registered, conversely the process proceeds to step S393 if it is registered.

In step S385, the center server 201 determines whether or not information as received includes the cookie information, the terminal 5 has accessed before if it includes, and therefore since the terminal 5 has the identification information as assigned (step S387), the process proceeds to step S389, conversely, the terminal 5 accesses for the first time if it does not include, and therefore since the identification information is not assigned, the process proceeds to step S387. In step S387, the center server 201 generates the identification information of the terminal 5. That is, in the case where the identification information of the terminal 5 is not registered relating to the received barcode (“NO” in step S383), if the received information does not include the cookie information, it is believed that the new user uses the barcode reader 102 for the first time and sends the new barcode for the first time, because of this, it is regarded that the code is original, and therefore the identification information is newly issued so as to provide with the service (the process in accordance with the code) by the present system.

After determining “YES” in step S385 or after step S387, in step S389, the center server 201 registers the identification information of the terminal 5 relating to the received barcode information in the code database. In step S391, the center server 201 generates the cookie information including the identification information of the terminal 5, and then returns.

That is, in the case where the identification information of the terminal 5 is not registered relating to the received barcode (“NO” in step S383), it is believed that the barcode is sent from the initial purchase user, because of this, it is regarded that the barcode is original, therefore the identification information is registered relating to the barcode in the code database, and the process proceeds to step S343 so as to provide with the service by the present system.

On the other hand, in step S393, the center server 201 determines whether or not the received information includes the cookie information, the terminal 5 has accessed before if it includes, and therefore the process proceeds to step S395, conversely, the terminal 5 accesses for the first time if it does not include, and therefore the process proceeds to step S399. In step S399, the center server 201 sends the error message to the terminal 5 irrespective of the barcode. That is, in the case where the identification information of the terminal 5 is registered relating to the received barcode (“YES” in step S383), if the received information does not include the cookie information, it is regarded that the new user other than the user of the original barcode uses the new barcode reader for the first time and the copy of the original barcode is sent, and therefore the provision of the service (the process in accordance with the barcode) by the present system is refused.

After determining “YES” in step S393, in step S395, the center server 201 compares the identification information of the terminal 5 registered relating to the barcode information in the code database with the identification information of the terminal 5 included in the received cookie information. Then, in step S397, the center server 201 regards the barcode as the original one if both are consistent, and the process proceeds to the step S391 so as to provide with service by the present system. However, if both are inconsistent, the center server 201 regards that the barcode is copied one transmitted from a person other than an initial purchase user, and proceeds to step S399 where the error message is sent to the terminal 5 irrespective of the barcode. Accordingly, it is possible to weed out use of an unauthorized copy of an original barcode as much as possible.

By the way, as described above, in accordance with the present embodiment and the modification example thereof, the code database relates the barcode to the identification information (the serial number of the barcode reader 102 or the identification information of the terminal 5) on the side of the barcode reader 102. If the identification information is not registered relating to the received barcode, it is believed that the barcode is sent from the initial purchase user, because of this, it is regarded that the barcode is original. As the result, the received identification information is registered relating to the barcode, and the service (the process in accordance with the barcode) by the present system is provided. On the other hand, if the identification information is registered relating to the received barcode, the registered identification information is compared with the received identification information. When both are consistent, the barcode is regarded as the original one, and the service (the process in accordance with the barcode) by the present system is provided. Conversely, both are inconsistent, it is regarded that the barcode is copied one transmitted from a person other than an initial purchase user, and therefore the provision of the service (the process in accordance with the barcode) by the present system is refused irrespective of the barcode. Accordingly, it is possible to weed out use of an unauthorized copy of an original barcode as much as possible.

Also, in the present embodiment, since the terminal 5 transmits the serial number required to authenticate (step S761) to the center server 201 in response to the command from the barcode reader 102, it is possible to weed out use of an unauthorized copy of an original barcode as much as possible without installing the dedicated software on the terminal 5.

In the modification example, by using the widely diffused existing cookie for the authentication (step S341), it is possible to weed out use of an unauthorized copy of an original barcode as much as possible without installing the dedicated software on the terminal 5.

Further, in accordance with the present embodiment and the modification example thereof, since the terminal 5 transmits the barcode to the center server 201 in response to the command from the barcode reader 102 of the terminal 5, it is possible to transmit the barcode without installing the dedicated software on the terminal 5.

### Fifth Embodiment

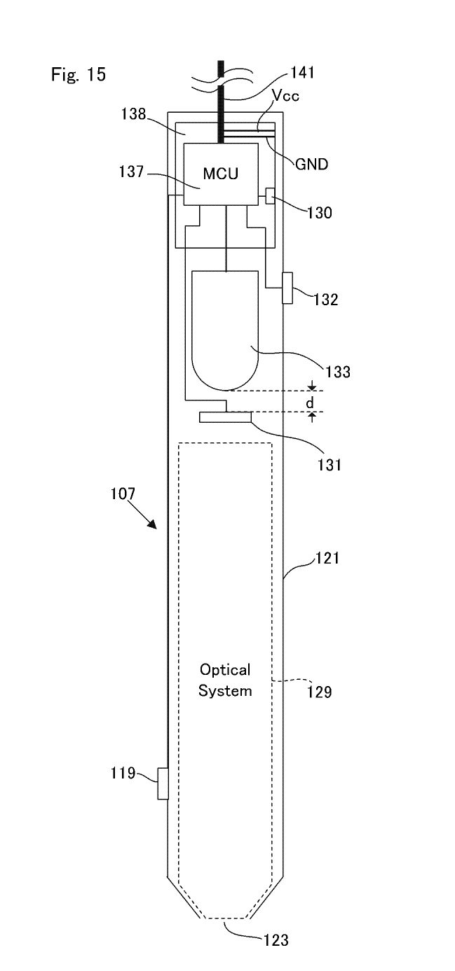

FIG. 15 is a structural drawing for showing a barcode reader 107 in accordance with the fifth embodiment. Referring to FIG. 15, the barcode reader 107 has a cylindrical housing 121. Then, a substrate 138 on which an MCU (Micro Controller Unit) 137 is mounted, a light emitting diode (LED) 133, an imaging element 131, a light emitting diode (LED) 130 which is turned on in a barcode mode, and an optical system 129 are housed in the housing 121. The imaging element 131 is, for example, an image sensor, a CCD, or the like. For example, the light emitting diode 133 emits infrared light. Also, a switch 131 for switching a mode (a mouse mode or the barcode mode) and a mouse button (click button) 119 are arranged on the housing 121. Further, the housing 121 is provided with an outgoing aperture 123 at the tip thereof, from which the light from the light emitting diode 133 is emitted. Still further, the light of the light emitting diode 133 which has been reflected by a surface to be photographed enters from the outgoing aperture 123, passes through the optical system 129, and then is inputted to the imaging element 131.

The substrate 138 is positioned at a base end section of the barcode reader 107. A power supply voltage Vcc and a ground voltage GND are supplied with the substrate 138 through a USB cable 141 whose one end is connected with the MCU 137, and then are supplied with the MCU 137, the imaging element 131, the light emitting diodes 130 and 133, and the switches 119 and 132.

The imaging element 131 photographs a surface to be photographed, and sends a photographed image to the MCU 137. The MCU 137 analyzes the photographed image. In the mouse mode, the MCU 137 computes a moving direction and a moving amount (i.e., a moving amount in an X direction and a moving amount in a Y direction) of the barcode reader 107 on the basis of the photographed images. Incidentally, the information of the moving direction and moving amount of the barcode reader 107 and the information of the mouse button 119, which are obtained in the mouse mode, may be called the mouse information. On the other hand, in the barcode mode, the MCU 137 decodes the barcode 104 on the basis of the photographed image to acquire the barcode information.

The MCU 137 has a function as a USB controller, and whereby communicates with a USB controller (not shown in the figure) which is connected with the other end of the USB cable 141 to transmit the mouse information or the barcode information.

The imaging element 131 is arranged to overlap with the light emitting diode 133 in a longitudinal direction of the barcode reader 107 and on a side, to which the light emitting diode 133 emits light. Also, since the emitted light from the light emitting diode 133 is required to reach the outgoing aperture 123, the size of the imaging element 131 is set so as not to block the emitted light from the light emitting diode 133. For example, when viewing from the outgoing aperture 123, their sizes are set so that the imaging element 131 is smaller than the light emitting diode 133 (its plastic mold).

Incidentally, if a distance “d” between the imaging element 131 and the light emitting diode 133 is too short, since there is a possibility that the imaging element 131 directly receives the emitted light from the light emitting diode 133, it is not possible to distinguish the light reflected by the surface to be photographed from it. Accordingly, care should be taken when setting the distance “d”.

The optical system 129 is designed so that an image of the surface to be photographed is focused onto the imaging element 131 on the basis of experiments, trial and error processes, and so on. For example, the optical system 129 includes a lens, a pinhole, and/or a mirror, and so on.

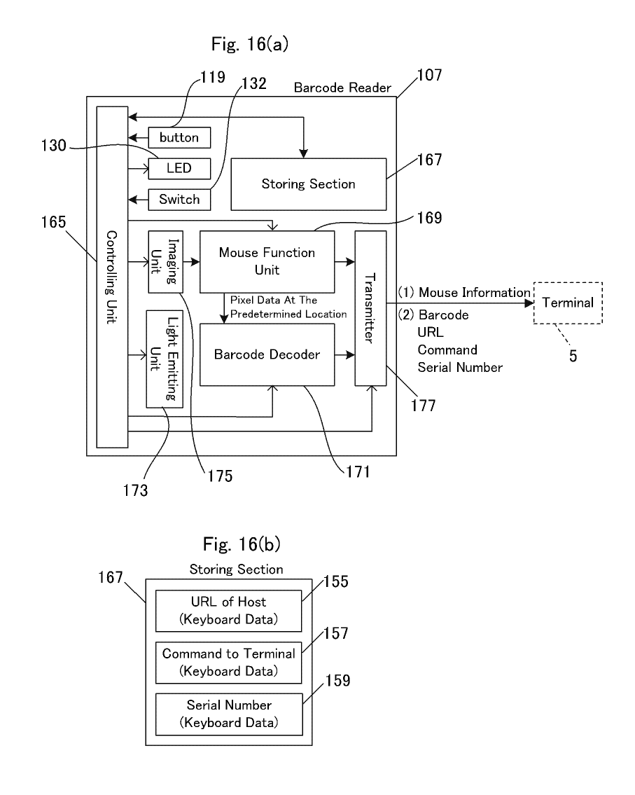

FIGS. 16(a) and 16(b) are functional block diagrams for showing the barcode reader 107 of FIG. 15. Referring to FIG. 16(a), the barcode reader 107 is provided with a controlling unit 165, a storing unit 167, a mouse function unit 169, a barcode decoder 171, a light emitting unit 173 including the LED 133, an imaging unit 175 including the imaging element 131, a transmitter 177, the mouse button 119, the switch 132, and the LED 130.

The barcode reader 107 implements the mouse mode and the barcode mode. The barcode reader 107 is set to the mouse mode by default. When the switch 132 is turned on, the controlling unit 165 enters the barcode mode, and turns on the LED 130. If the scan of the barcode 104 is successfully carried out, the controlling unit 165 turns off the LED 130 and enters the mouse mode. Also, even in either case of the mouse mode and the barcode mode, the controlling unit 165 performs the photographing by the imaging unit 175 and the light emitting by the light emitting unit 173.

First, the mouse mode will be described. The controlling unit 165 notifies the mouse function unit 169 that the current mode is the mouse mode, and the mouse function unit 169 computes the moving direction and the moving amount of the barcode reader 107 in response thereto. The particularity is as follows.

The imaging unit 175 photographs the surface to be photographed, i.e., a surface with which the outcoming aperture 123 contacts in a predetermined period T, and sequentially outputs frame pictures as obtained to the mouse function unit 169. The mouse function unit 169 converts these frame pictures into digital data and stores them, computes the moving direction and the moving amount of the barcode reader 107 by comparing the same images (e.g., a specified pattern on a desk, which is the surface to be photographed) in the respective frame pictures, and sends them to the transmitter 177. Then, the transmitter 177 transmits the moving direction and the moving amount as received and the information of the mouse button 119 (the mouse information) to the terminal 5.

Next, the barcode mode will be described. The controlling unit 165 notifies the mouse function unit 169 and the barcode decoder 171 that the current mode is the barcode mode, in response thereto, the mouse function unit 169 performs the processing for the barcode mode, and the barcode decoder 171 decodes the barcode 104 to acquire the barcode information. The particularity is as follows.

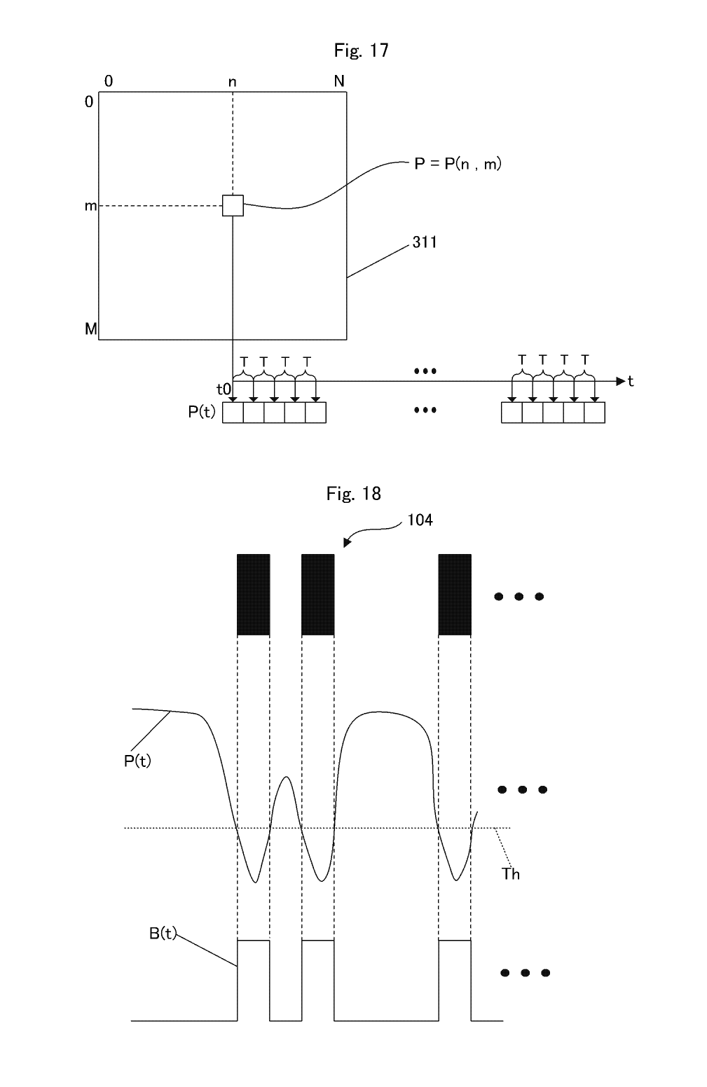

FIG. 17 is an explanatory view for showing a barcode reading method of the barcode reader 107 of FIG. 15. Referring to FIG. 17, it is assumed that a frame picture 311 outputted from the imaging unit 175 has been converted into the digital data. The imaging element 131 of the imaging unit 175, i.e., the frame picture 311 consists of (N+1)*(M+1) of pixels. The mouse function unit 169 outputs pixel data P (n, m) at a predetermined location (n, m) to the barcode decoder 171 each time the frame picture 311 is acquired. That is, the mouse function unit 169 sequentially outputs the pixel data P (n, m) to the barcode decoder 171 in the imaging period T of the imaging unit 175. The references “n” and “m” represent constants respectively.

Meanwhile, the pixel data P(n,m), which is sequentially outputted, is referred to as “P(t)”. The variable “t” is a value of integral multiple of the imaging period T.

FIG. 18 is a view for showing examples of the barcode 104, the pixel data P(t) at the predetermined location (n, m) in the frame picture 311, and the binary data B(t) thereof. Referring to FIG. 18, level of the pixel data P(t) changes depending on a black-and-white pattern of the barcode 104. That is, level of brightness decreases when the pixel data P(t) represents a black bar, and conversely the level of the brightness increases when the pixel data P(t) represents a white spacing.

The barcode decoder 171 compares the pixel data P(t) as sequentially inputted with a predetermined threshold value Th to obtain the binary data B(t). That is, the barcode decoder 171 determines that the pixel data P(t) represents the white spacing when the pixel data P(t) exceeds the predetermined threshold value Th, and sets the binary data B(t) of the pixel data P(t) to “0”. On the other hand, the barcode decoder 171 determines that the pixel data P(t) represents the black bar when the pixel data P(t) is the predetermined threshold value Th or less, and sets the binary data B(t) of the pixel data P(t) to “1”.

In this way, the barcode decoder 171 binarizes the pixel data P(t) as sequentially inputted, and decodes the barcode 104 based on the obtained data B(t) by means of a known decoding technique. Then, the barcode decoder 171 converts the result of the decoding, i.e., the barcode information into the keyboard data and then outputs it to the transmitter 177. Also, the barcode decoder 171 acquires the URL 155, the command to the terminal 5, and the serial number 159 from the storing unit 167 (see FIG. 6(b)), and sends them to the transmitter 177. The transmitter 177 transmits the barcode information, the URL 155, the command 157, and the serial number as received to the terminal 5.

Incidentally, the URL 155, the command 157, and the serial number 159 are stored in the storing unit 167 in the form of the keyboard data. The URL 155 is a URL of the host computer 100 or a URL of the center server 201. The command 157 is a command which is used to instruct the terminal 5 to run a browser and transmit the barcode information to the computer (100 or 201) by the use of the URL 155. The serial number 159 is a unique number that is assigned to identify the barcode reader 107.

By the way, returning to FIG. 15, the MCU 137 includes, as built-in elements, a CPU, a RAM, a ROM, an A/D converter, a USB controller, and so forth (not shown in the figure). Meanwhile, it is possible to make changeable the URL and the programs by the use of an EEPROM, a flash memory or the like, provided outside the MCU 137.

The CPU of the MCU 137 functions as the controlling unit 165, the mouse function unit 169, and the barcode decoder 171 by executing the programs stored in the ROM. The RAM and ROM of the MCU 137 function as the storing unit 167. The USB controller of the MCU 137 functions as the transmitter 177. The A/D converter of the MCU 137 functions as the imaging unit 175 together with the imaging element 131.

Returning to FIG. 16(a) again, the terminal 5 controls movement of a cursor on a monitor on the basis of the mouse information sent by the transmitter 177 in the mouse mode. Also, in response to the command 157 sent by the transmitter 177 in the barcode mode, the terminal 5 transmits the barcode information and the serial number 159 as received to the host computer 1 with reference to the received URL 155 through the network 9. Incidentally, while the personal information of the user can optionally be registered from the terminal 5, it requires careful handling. In connection with the serial number 159 which is acquired by the host computer 100 and the center server 201, the personal information has to be handled particularly in a careful way.

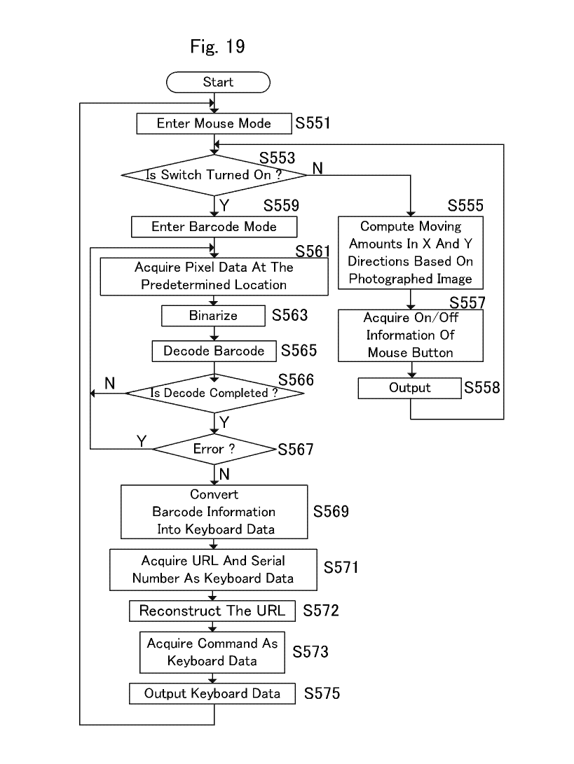

FIG. 19 is a flow chart for showing the processing of the MCU 137 of FIG. 15. Referring to FIG. 19, in step S551, the MCU 137 enters the mouse mode. In step S553, the MCU 137 determines whether or not the switch 79 is turned on, the process proceeds to step S559 so as to enter the barcode mode if it is turned on, conversely if it is turned off, since the mode is the mouse mode, the process proceeds to step S555.

The processes of the steps S555 to S558 are for the mouse mode. In step S555, the MCU 137 computes the moving amount in the X direction and the moving amount in the Y direction on the basis of the photographed image by the imaging element 131. In step S557, the MCU 137 acquires the on/off information of the mouse button 119. In step S557, the MCU 137 transmits the moving amount in the X direction and the moving amount in the Y direction of the barcode reader 107, and the on/off information of the mouse button 119 to the terminal 5, and then returns to step S553.

On the other hand, the processes of step S559 and the subsequent steps are for the barcode mode. In step S559, the MCU 137 enters the barcode mode and turns on the LED 130. In step S561, the MCU 137 acquires the pixel data P(t) at the predetermined location (n, m). In step S563, the MCU 137 compares the pixel data P(t) with the predetermined threshold value Th to binarize the pixel data P(t), and whereby obtains the binary data B(t). In step S565, the MCU 137 decodes the binary data B(t) based on the known barcode decode technique. In step S566, the MCU 137 proceeds to step S567 if the decode of the barcode is completed, conversely the MCU 137 returns to step S561 if it is not completed.

When the MCU 137 determines in the step S567 that the decode of the barcode 104 has not been completed correctly, the MCU 137 returns to step S561, conversely when the MCU 137 determines in the step S567 that the decode of the barcode 104 has been completed correctly, the MCU 137 proceeds to step S569.

In step S569, the MCU 137 converts the barcode information as the decoding result (e.g., “4560256580016”) into keyboard data and stores it in a RAM (not shown in the figure). In step S571, the MCU 137 acquires URL 155 (e.g., “http://www.ssd.co.jp”) and the serial number 159 (e.g., “13222159”) from the storing unit 167 as keyboard data. Then, in step S572, the MCU 137 appends the barcode information and the serial number 159 as keyboard data to the end of the URL 155 as acquired, and stores it in the RAM (not shown in the figure) as a new URL (e.g., “http://www.ssd.co.jp/?bc=4560256580016&sn=13222159”).

In step S573, the MCU 137 acquires the command 157 from the storing unit 167 in the form of keyboard data, and stores the command in the RAM (not shown in the figure). In step S575, the MCU 137 outputs the keyboard data (the command 157, the URL 155, the serial number 159, and the barcode information) as obtained in steps S569 and S573 to the terminal 5, and then returns to step S551 so as to enter the mouse mode and turn off the LED 130.

By the way, as described above, in accordance with the present embodiment, the imaging element 131 is arranged to overlap with the light emitting diode 133 in a longitudinal direction of the barcode reader 107. In other words, the imaging element 131 is arranged between the outgoing aperture 123 from which the light of the light emitting diode 133 is emitted outside and the light emitting diode 133. Accordingly, it is possible to house the each element (137, 138, 133, 131, 129, and so on) in the tubular housing 121 which is relatively long and thin, and therefore it is possible to provide the so-called pen type barcode reader with the mouse function.

Also, in accordance with the present embodiment, since the barcode reader 107 implements the mouse function, the barcode reader 107 serves also as a pointing device. Accordingly, the user can manipulate the terminal 5 only by operating the barcode reader 107 as a mouse after scanning the barcode 104 by the barcode reader 107, and whereby the structure is very user-friendly.

Further, in the present embodiment, the barcode 104 is decoded on the basis of the temporally-continued pixel data items at the predetermined location without depending on image analysis for decoding the barcode 104 on the basis of the image of the barcode on the picture as obtained even though the imaging element 131 is implemented. In this way, the barcode reader 107 based on the novel barcode reading method is realized.

Meanwhile, the present invention is not limited to the above embodiment, and a variety of variations may be effected without departing from the spirit and scope thereof, as described in the following modification examples.

(1) In the first to third embodiments, the URLs of the servers W-k and C-m are related to the serial numbers in the databases 11 and 106. However, the URL to be related to the serial number is not limited to one indicating only the server, and may indicate the other resource on the network 9 (for example, a directory, a file, an image, a sound, a document, or the like in the server). This is true also in the case of the fourth embodiment.

(2) In the first to third embodiments 1 to 3, the WEB page or the content sent from the server W-k or C-m is displayed on the terminal 5. However, before displaying the WEB page or the content sent from the server W-k or C-m on the terminal 5, an WEB page or a content (e.g., a trademark and so on of the operating entity running the host computer 1 or 100) may be displayed on the terminal just for a fixed time in accordance with an instruction from the host computer 1 or 100, and subsequently, the WEB page or the content sent from the server W-k or C-m may automatically be displayed on the terminal 5.

In this case, for example, in a stage before the step S71 of FIG. 4, i.e., in response to the receipt of the serial number from the terminal 5, a predetermined URL is sent to the terminal 5, and the access to the predetermined URL is instructed. Hence, the WEB page or the content is sent from a server addressed by the predetermined URL to the terminal 5. During this time, the host computer 1 performs the process of the step S71. Then, the host computer 1 performs the process of the step S73 after the elapse of a certain period of time from the send of the predetermined URL. Hence, eventually, the WEB page is automatically sent from the server associated with the serial number to the terminal 5.

Also, for example, in a stage before the step S180 of FIG. 8, i.e., in response to the receipt of the serial number and the barcode from the terminal 5, a predetermined URL is sent to the terminal 5, and the access to the predetermined URL is instructed. Hence, the WEB page or the content is sent from a server addressed by the predetermined URL to the terminal 5. During this time, the host computer 1 performs the processes of the steps S180 and S182. Then, the host computer 1 performs the process of the step S184 after the elapse of a certain period of time from the send of the predetermined URL. Hence, eventually, the WEB page is automatically sent from the server associated with the serial number to the terminal 5.

(3) In the first to third embodiments, the URL which is related to the serial number may be dynamically changed in the database 11 or 106 in accordance with a period of time, time and data, or the like when the host computer 1 or 100 is accessed.

(4) In the first to third embodiments, the identification information (the serial number) assigned to the USB device 7 or the barcode reader 102 is used as identification information on the side of the USB device 7 or the barcode reader 102. However, identification information of the terminal 5 or identification information of a user may be used as the identification information on the side of the USB device 7 or the barcode reader 102, and may be related to the URL of the server W-k or C-m. Also, a combination of all or a part of the identification information of the USB device 7 or the barcode reader 102, the identification information of the terminal 5, and the identification information of the user may be used.

(5) In the modification example of the fourth embodiment, the identification information of the terminal 5 to which the barcode reader 102 is connected is generated as identification information on the side of the barcode reader 102 which is required to authenticate the barcode (step S387 of FIG. 13). However, the identification information on the side of the barcode reader 102 is not limited to the identification information of the terminal 5 because hardware, software, and/or a user on the side of the barcode reader 102 has only to be able to be identified, and may be the identification information of the barcode reader 102, the identification information of the user, or the like, or a combination of all or a part of them.

(6) In the fourth embodiment and the modification example thereof, the authentication process of the barcode uses the serial number of the barcode reader 102, which is preliminarily assigned, or the identification information of the terminal 5, which is assigned by the center server 201. However, the authentication process of the barcode may use identification information which the user sends to the center server 201 through the terminal 5.

For example, a barcode for displaying a login screen into the center server 201 on the terminal 5 is provided. When the user scans this barcode by the barcode reader 102, the center server 201 sends the login screen to the terminal. The user inputs user identification information (ID) and/or a password (hereinafter referred to as the “user authentication information”) from the login screen using an input interface such as a keyboard of the terminal 5. And, the center server 201 saves the user authentication information as input. In this case, a code database registers relating the user authentication information to the barcode. Also, the user authentication information may be included in the cookie instead of the identification information of the terminal 5 which is included in the cookie information in the above modification example, and whereby it is convenient for the user.

The flow of the authentication process based on the user authentication information will be described using FIG. 11. In step S281, the center server 201 retrieves the received barcode information from the code database. In step S283, the center server 201 determines whether or not the user authentication information is registered relating to the retrieved barcode information, the process proceeds to step S285 if it is not registered, conversely the process proceeds to step S287 if it is registered.

In step S285, the center server 201 registers relating the received barcode information to the user authentication information as input in logging in currently in the code database, and then returns. That is, if the user authentication information is not registered relating to the received barcode (“NO” in step S283), it is regarded that the barcode is sent from the initial purchase user and therefore is original, the user authentication information as input in currently logging in is registered relating to the barcode in the code database, and furthermore the process proceeds to step S763 (see FIG. 14) so as to provide with the service by the present system.

On the other hand, in step S287, the center server 201 compares the user authentication information registered relating to the barcode in the code database 209 with the user authentication information as input in logging in currently. And, in step S289, the center server 201 regards the barcode as original one if both are consistent, and proceeds to step S763 so as to provide with the service by the present system. However, if both are inconsistent, the center server 201 regards that the barcode is copied one transmitted from a person other than an initial purchase user, and proceeds to step S291 where the error message is sent to the terminal 5 irrespective of the barcode. Accordingly, it is possible to weed out use of an unauthorized copy of an original barcode as much as possible.

(7) In the fourth embodiment and the modification example thereof, it is preferred that the respective barcodes to be distributed are unique. In this case, it is possible to prevent the barcodes from draining by restricting the duration of use of the respective barcodes.

(8) In the fourth embodiment and the modification example thereof, in the case where it is determined that the barcode is the copied one, the error message is sent to the terminal 5 (steps S291 and S399). However, in this case, a web site such as a URL of a well-known portal site, which has nothing to do with the service by the present system, may be sent.

(9) In the fifth embodiment, the light emitting diode 133 and the imaging element 131 are arranged in a linear fashion along the longitudinal direction of the housing 121. However, if the elements such as the light emitting diode 133, the imaging element 131, and the MCU 137 are housed in a tubular housing and thereby the pen type barcode reader with the mouse function can be constituted, the arrangement of the respective elements may be optional. Also, a cross-section surface of the tubular housing is not limited to a circular shape, and may have any cross-sectional shape such as an ellipsoidal shape, a polygonal shape, any curve profile, any linear shape, and a combination thereof.

(10) A USB device usable in the first embodiment is not limited to the USB device 7, various USB devices such as a USB memory are usable. Also, although the device and the barcode reader conform to the USB in the first to fifth embodiments, these are not limited thereto. Further, although these are recognized as a keyboard by the terminal, these are not limited thereto.

(11) It is also possible to use the barcode recognition feature implemented with the camera of a cellular phone in place of the barcode reader 102 in the second and fourth embodiments. This is true in the case of the recognition of QR codes. In this case, for example, a serial number (identification information) is assigned to the cellular phone, and software is installed in the cellular phone. The software is for transmitting the barcode and the serial number to the host computer 100 or the center server 201.

(12) In the second and fourth embodiments, the host computer 100 and the center server 201 transmits the barcode information to the content server C-m indirectly by passing through the terminal 5. However, the host computer 100 and the center server 201 may transmit the barcode information to the content server C-m directly without passing through the terminal 5.

(13) In the above description, the USB device 7, and the barcode readers 102 and 107 are connected to the terminal 5 in a wired manner. However, these may be connected to each other in a wireless manner using RF, an infrared ray, or the like.

(14) As physically viewed, each of the host computer 1, the host computer 100, and the center server 201 can be implemented with a single computer. Alternatively, the processes of each of the host computer 1, the host computer 100, and the center server 201 can be performed by a plurality of computers as distributed processing. Of course, in the case where distributed processing is employed, the respective computers may be located in the same country, or distributed in a plurality of countries. Meanwhile, the host computer 1, the host computer 100, and the center server 201 as referred to herein are devices which are implemented by means of hardware and/or software. These are true also in the case of the servers W-k and C-m.

(15) In the second and fourth embodiments, while the barcode 104 are employed as the information to be transmitted to the host computer 100 and the center server 201, the present invention is not limited thereto. For example, an electronic tag (IC tag) such as RFID (Radio Frequency Identification System) can be used. However, in this case, the information encoded in the electronic tag is read by an electronic tag reader (IC tag reader) in place of the barcode reader 102. Preferably, the electronic tag reader is designed to issue the same command as the barcode reader 102, and output the URL of the host computer 100 or the center server 201. Also, while a one-dimensional barcode which is a one-dimensional code is used in the above examples, it is possible to use a two-dimensional barcode or QR code as a two-dimensional code.

(16) In the fourth embodiment, the center server 201 and the content server C-m may be recognized unifying as a computer on the side supplying the service, and therefore may be collectively called a host computer.

(17) In the case of the above examples, there is no need to install dedicated software in the terminal 5 for transmitting the serial number and the barcode through a browser to the host computer 1 or 100, or the center server 201 because the USB device 7, and the barcode readers 102 and 107 are designed to output the command. However, it is also possible to omit the functionality of outputting the command from the USB device 7, and the barcode readers 102 and 107, by installing such dedicated software in the terminal 5. In this case, it is preferred to launch the dedicated software in response to the input of the serial number and the barcode, and automatically transmit the serial number and the barcode. Also, it is possible to have the USB device 7, and the barcode readers 102 and 107 output a command to the dedicated software, which then transmits the serial number and the barcode to the USB device 7, or the barcode reader 102 or 107 in response to the command.

Furthermore, in the case of the above examples, the USB device 7, and the barcode readers 102 and 107 are designed to output the URL of the host computer 1 or 100, or the center server 201, such that there is no need to input the URL of the host computers 1 and 100, and the center server 201 to the terminal 5. However, it is also possible to omit the functionality of outputting the URL from the USB device 7, and the barcode readers 102 and 107 by prompting the user to input the URL of the host computer 1 or 100, or the center server 201, or by writing the above software to include the URL in the terminal 5.

While the present invention has been described in detail in terms of embodiments, it is apparent that those skilled in the art will recognize that the invention is not limited to the embodiments as explained in this application. The present invention can be practiced with modification and alteration within the spirit and scope of the present invention as defined by the appended any one of claims.

1. An automatic access system comprising:
a device configured to be freely removably connected to a terminal connected to a network; and
a host computer configured to be connected to the network,
wherein said device including:
a storing unit configured to store identification information assigned to said device and address information of said host computer (hereinafter referred to as “host address information”); and
an information processing unit configured to transmit the identification information and the host address information to the terminal in response to that said device is connected to the terminal,
wherein said host computer receives the identification information which the terminal transmits on the basis of the host address information in response to the connection of said device, retrieves address information item related to the received identification information from address information items of a plurality of resources on the network, and transmits the retrieved address information item to the terminal.

2. The automatic access system as claimed in claim 1, wherein said storing unit of said device stores a command to an operating system of the terminal,
wherein said information processing unit transmits the command to the terminal together with the identification information and the host address information in response to that the device is connected to the terminal, and
wherein said host computer receives the identification information which the terminal transmits on the basis of the host address information in response to the command.

3-4. (canceled)

5. An automatic access system comprising:
a responding unit configured to be installed on a terminal connected to a network, and perform processing in response to that a device is connected to the terminal; and
a host computer configured to be connected to the network,
wherein said responding unit transmits identification information on a side of the device to the host computer on the basis of address information of said host computer (hereinafter referred to as “host address information”) in response to that the device is connected to the terminal, and
wherein said host computer receives the identification information, retrieves address information item related to the received identification information from address information items of a plurality of resources on the network, and transmits the retrieved address information item to the terminal.

6. (canceled)

7. The automatic access system as claimed in claim 5, wherein the identification information and/or the host address information are/is sent to said responding unit by said device.

8. (canceled)

9. The automatic access system as claimed in claim 1, wherein said device is a code reader which reads and decodes a code.

10. The automatic access system as claimed in claim 9, wherein said host computer receives the code decoded by said device from the terminal, and indirectly or directly transmits the code to the resource indicated by the address information item related to the identification information of said device.

11. The automatic access system as claimed in claim 1, wherein said device is set so as to be recognized as a keyboard by the terminal.

12. (canceled)

13. The automatic access system as claimed in claim 1, wherein the code includes a one-dimensional code, a two-dimensional code, and/or a code which is stored in an IC tag.

14. (canceled)

15. The host computer recited in claim 1.

16. The device recited in claim 5.

17. A responding device comprising the responding unit recited in claim 1.

18. An automatic access method utilizing a device configured to be freely removably connected to a terminal connected to a network, and a host computer configured to be connected to the network, comprising the steps of:
by the host computer, receiving identification information on a side of the device which the terminal transmits on the basis of address information of the host computer (hereinafter referred to as “host address information”) in response to the connection of the device;
by the host computer, retrieving address information item related to the received identification information from address information items of a plurality of resources on the network; and
by the host computer, transmitting the retrieved address information item to the terminal.

19. (canceled)

20. An automatic access method utilizing a device configured to be freely removably connected to a terminal connected to a network, and a host computer configured to be connected to the network, comprising the steps of:
transmitting identification information on a side of the device to the host computer on the basis of address information of said host computer (hereinafter referred to as “host address information”) in response to that the device is connected to the terminal; and
receiving address information item related to the identification information received by the host computer, of address information items of a plurality of resources on the network, from the host computer.

21-22. (canceled)

23. A computer readable medium embodying a computer program for making a computer perform the automatic access method recited in claim 18.

24-48. (canceled)

49. The automatic access system as claimed in claim 5, wherein said device is a code reader which reads and decodes a code.

50. The automatic access system as claimed in claim 49, wherein said host computer receives the code decoded by said device from the terminal, and indirectly or directly transmits the code to the resource indicated by the address information item related to the identification information of said device.

51. The automatic access system as claimed in claim 5, wherein said device is set so as to be recognized as a keyboard by the terminal.

52. The automatic access system as claimed in claim 5, wherein the code includes a one-dimensional code, a two-dimensional code, and/or a code which is stored in an IC tag.

53. A host computer configured to operate with a responding unit configured to be installed on a terminal connected to a network, and perform processing in response to that a device is connected to the terminal, wherein the responding unit transmits identification information on a side of the device to the host computer on the basis of address information of the host computer in response to that the device is connected to the terminal, wherein
the host computer is configured to be connected to the network; and
the host computer receives the identification information, retrieves address information item related to the received identification information from address information items of a plurality of resources on the network, and transmits the retrieved address information item to the terminal.

54. A device configured to operate with a host computer configured to be connected to a network, wherein the host computer receives the identification information which a terminal transmits on the basis of address information of the host computer in response to the connection of the device, retrieves address information item related to the received identification information from address information items of a plurality of resources on the network, and transmits the retrieved address information item to the terminal, wherein
the device is configured to be freely removably connected to the terminal when the terminal is connected to the network; the device comprising:
a storing unit configured to store identification information assigned to the device and the address information of the host computer; and
an information processing unit configured to transmit the identification information and the address information of the host computer to the terminal in response to that the device is connected to the terminal,

55. A responding unit configured to operate with a host computer configured to be connected to a network, wherein the host computer receives the identification information, retrieves address information item related to the received identification information from address information items of a plurality of resources on the network, and transmits the retrieved address information item to a terminal, wherein
the responding unit is configured to be installed on a terminal connected to the network, and perform processing in response to that a device is connected to the terminal; and
the responding unit transmits identification information on a side of the device to the host computer on the basis of address information of the host computer in response to that the device is connected to the terminal.

56. A computer readable medium embodying a computer program for making a computer perform the automatic access method recited in claim 20.
